(19) United States
(12) Patent Application Publication
(10) Pub. No.: US 2013/0113417 A1
(43) Pub. Date: May 9, 2013

(54) CHARGE CONTROL DEVICE AND CHARGE CONTROL METHOD

(71) Applicant: Sony Corporation, Tokyo (JP)

(72) Inventor: Ryoichi Nakashima, Tokyo (JP)

(73) Assignee: SONY CORPORATION, Tokyo (JP)

(21) Appl. No.: 13/667,518

(22) Filed: Nov. 2, 2012

(30) Foreign Application Priority Data
Nov. 9, 2011 (JP) 2011-245090

(51) Int. Cl. H02J 7/00

(52) U.S. Cl. 320/107; 320/162

(57) ABSTRACT

A charge control device includes a current acquisition unit that acquires a charge current value of each battery, and a main charge unit that performs main charge for each battery based on the charge current value acquired by the current acquisition unit.

### BACKGROUND

The present disclosure relates to a charge control device and a charge control method that control a charging operation of a secondary battery used as the main power source of portable electronic devices, and particularly to a charge control device and a charge control method that controls a charging operation of a plurality of secondary batteries.

In recent years, portable electronic devices including digital cameras, personal computers (PCs), mobile telephones, tablet computers, and the like have been widely used. Electronic devices of this type fundamentally use batteries as the main power source. Most batteries used in electronic devices are secondary batteries, and when the capacity thereof becomes low, a commercial power source is used so that the devices can be re-used many times over. A lithium-ion battery, for example, is considered to be suitable for portable devices since the capacity of the battery per volume and per weight is large.

A method for efficiently charging a battery for a device such as, for example, a digital camera assumed to be used in an outdoor place where a commercial power source is not provided so that rapid charging is difficult has been demanded. In addition, in order to drive a device for a long period of time even in a place where it is difficult to charge the device, it is also possible to connect the device to an extension battery from outside, in addition to having another battery built-in. For example, a “vertical position grip” that is an accessory for vertical position capturing of a digital single-lens reflex camera can include a plurality of batteries (for example, refer to Japanese Unexamined Patent Application Publication No. 2009-58921 (PTL 1)).

FIG. 9 shows a charge characteristic of a lithium-ion battery according to the first embodiment of the present disclosure. The drawing has an example of a characteristic of a battery pack in which two battery cells are connected in series, and the horizontal axis represents a time axis and the vertical axis represents a charge current and a charge voltage (battery voltage). Here, it is assumed to perform charging with a constant voltage power source of 8.4 V that is equivalent to the battery voltage of two battery packs.

During the initial charge with a small capacity, the battery voltage (output battery voltage) is in a low state, and if charging is performed with a high current, there is concern that the battery is heated or deteriorates. For this reason, it is necessary to provide a protective circuit and then perform charging with a low current. In the example illustrated in FIG. 9, charging is performed with a constant current, that is, constant electric power, maintaining a charge current of 100 mA at the time of the initial charge.

When the capacity is accumulated to a certain degree owing to charging, the battery voltage gradually increases. Then, when the charge voltage reaches 6 V, heating or deterioration does not occur even if charging is performed with a high current, and accordingly, the charge current increases, which is efficient. In the example shown in FIG. 9, charging with a constant current, that is, charging with constant electric power is performed using a charge current of 1500 mA.

After that, if charging proceeds further, the potential difference between a power source voltage for charging and the battery voltage becomes small, and thus, the charge current gradually decreases. In the example illustrated in FIG. 9, charging is completed at the time when the charge current is lowered and reaches 50 mA. The area obtained through integration of the charging curve shown in the drawing to the time direction corresponds to the charge capacity of a battery.

To summarize the above, in a secondary battery such as a lithium-ion battery, and the like, there is a definite relationship between a charge voltage and a charge current, and it can be assumed that there is a premise as follows during charging.

(Premise 1) If charging is performed with a high current when a battery voltage is low, heating or deterioration of the battery occurs, and therefore, it is necessary to provide a protective circuit and then perform charge with a low current. On the contrary, when a battery voltage is high, the potential difference between a power source voltage and the battery voltage becomes small, and therefore, a charge current becomes low.

Furthermore, other premises of a charging time of a secondary battery such as a lithium-ion battery, or the like can be raised as follows.

(Premise 2) Since internal impedance under low temperatures is high in comparison to a case under normal temperatures, a charge current becomes low.

(Premise 3) If charging and discharging are repeated, the internal impedance becomes high in comparison to a new product, and thus, a charge current becomes low. The great internal impedance due to repeated charging and discharging is equivalent to “deterioration” of a battery. There is a tendency that a secondary battery such as a lithium-ion battery, which is fully charged and then left alone, easily deteriorates in comparison to a secondary battery which is half-charged and then left alone.

(Premise 4) Most batteries for electronic devices constitute “assembled batteries” formed by connecting a plurality of battery cells. If battery cells are connected in parallel, the battery cells can be charged with a higher current than a battery only with one cell.

(Premise 5) Secondary batteries such as lithium-ion batteries should be provided with a protective circuit and lower a charge voltage when the batteries are charged at a low or high temperature in order to meet safety regulations such as the Electrical Appliances and Material Safety Act. For this reason, the charge current becomes lower. Further, since currents are limited by providing a protective circuit in order to meet safety regulations such as the electrical appliances and material safety act, charge currents may become low.

(Premise 6) There are various charge power sources such as a USB (Universal Serial Bus), an AC adaptor, and the like. The power source supply capacities vary depending on the charge power sources, and even when the same battery with the same battery voltage is charged, charge currents differ.

(Premise 7) When a plurality of batteries are sequentially charged using one charger, the time taken to cause all of the batteries to be fully charged is not affected by the charge order. However, when charging is stopped before all of the batteries are fully charged, it is more efficient to sequentially charge batteries with a high charge current to batteries with a low charge current than to sequentially charge batteries with a low charge current to batteries with a high charge current since the integrated value of charge currents, that is, the total charged amount of all batteries in the former case is greater. In the present disclosure, the meaning of the term “efficiency” of charge is used in this way unless specified otherwise.

There are chargers that sequentially charge a plurality of batteries. The charger AC-VQ900AM made by Sony Corporation, for example, charges two battery packs for digital single-lens reflex cameras in a relay manner (for example, refer to http://www.sony.jp/ichigan/products/AC-VQ900AM/index.html (as of Oct. 11, 2011) (NPL 1)). This charger has two sockets No. 1 and No. 2, and when battery packs are simultaneously inserted into the respective sockets, the charger performs charging from a battery pack inserted in the No. 1 socket. In addition, when charging is started in the state in which two battery packs are inserted, charging is performed from a battery pack inserted in the No. 1 socket.

In addition, a charging and discharging method has been proposed in which a battery unit including a storage device into which charge permission or non-permission information is written is charged (for example, refer to Japanese Patent No. 3890168 (PTL 2)). According to the charging and discharging method, a charger determines a charge order by reading charge permission or non-permission information from the battery unit and writes such charge permission or non-permission information into the battery unit in accordance with a charge state.

In addition, a charger has been proposed by which respective voltages (charge amounts) of a plurality of charge batteries are measured and the charge batteries are sequentially charged from those with a high voltage or those with a low voltage (for example, refer to Japanese Unexamined Patent Application Publication No. 4-244742 (PTL 3)).

In addition, a charging method and a device which cause a plurality of batteries to be in a practical charge state and then to be fully charged have been proposed. The “practical charge state” mentioned here is a state in which the capacity increases little even if charging is continued. There are methods of determining practical charge, one of which is determined based on a charge current value that is equal to or lower than a threshold value (for example, refer to Japanese Patent No. 4068275 (PTL 4)) and the other is determined based a current integrated value or an electric power (=a charge current×a voltage) integrated value (for example, refer to Japanese Patent No. 3571536 (PTL 5)).

In addition, a charger has been proposed by which initial charge of a plurality of batteries are completed and then the order of the batteries for performing rapid charge is determined (for example, refer to Japanese Patent No. 3011840 (PTL 6)).

However, in the techniques disclosed in the above documents (NPL 1 and PTL 2 to PTL 6), there is a problem in that if charging is sequentially performed from batteries having a low voltage and a working protective circuit to batteries in a normal state, efficient charging is difficult.

In addition, in the techniques disclosed in the above documents (NPL 1 and PTL 2 to PTL 6), there is a problem in that, if charging is sequentially performed from batteries which are nearly fully charged to batteries in a normal state, efficient charging is difficult. However, in the technique disclosed in PTL 2, such a problem can be avoided to a certain degree by writing charge history information into a storage region of a battery.

Further, in the techniques disclosed in the above documents (NPL 1 and PTL 2 to PTL 6), there is a problem in that, if charging is sequentially performed from batteries with a low temperature to batteries in a normal state, efficient charging is difficult.

Further, in the techniques disclosed in the above documents (NPL 1 and PTL 2 to PTL 6), there is a problem in that, if charging is sequentially performed from deteriorated batteries to batteries in a normal state, efficient charging is difficult. However, in the technique disclosed in PTL 2, such a problem can be avoided to a certain degree by writing charge history information into a storing area of a battery.

Further, in the techniques disclosed in the above documents (NPL 1 and PTL 2 to PTL 6), there is a problem in that, if charging is sequentially performed from assembled batteries having a small number of battery cells connected in parallel to assembled batteries having a large number of battery cells connected in parallel, efficient charging is difficult. However, in the technique disclosed in PTL 2, such a problem can be avoided to a certain degree by writing charge history information into a storing area of a battery.

Further, in the techniques disclosed in the above documents (NPL 1 and PTL 2 to PTL 6), there is a problem in that, if charging is sequentially performed from batteries of which the temperature is regulated, based on a safety standard, to batteries in a normal state, efficient charging is difficult.

Further, in the techniques disclosed in the above documents (NPL 1 and PTL 2 to PTL 6), there is a problem in that, if charging is sequentially performed from batteries which are nearly fully charged to batteries in a normal state, the batteries which are nearly fully charged are repeatedly charged, and thereby deterioration thereof tends to further occur. In PTL 3, for example, such a problem tends to occur when charging is performed from batteries having a high voltage (charged amount).

Further, in the techniques disclosed in the above documents (NPL 1 and PTL 2 to PTL 6), there is a problem in that, if charging is sequentially performed from deteriorated batteries to batteries in a normal state, only the deteriorated batteries are repeatedly charged, and thereby deterioration thereof tends to further occur. However, in the technique disclosed in PTL 2, such a problem can be avoided to a certain degree by writing charge history information into a storing area of a battery.

### SUMMARY

It is desirable to provide an excellent charge control device and an excellent charge control method which have satisfactory control of a charge operation of a plurality of secondary batteries.

It is further desirable to provide an excellent charge control device and an excellent charge control method which can charge a plurality of secondary batteries in an appropriate order with high efficiency.

It is further desirable to provide an excellent charge control device and an excellent charge control method which can charge a plurality of secondary batteries having various amounts of charge, temperature states, degree of deterioration, and the number of battery cells connected in parallel in an appropriate order with high efficiency.

The present disclosure takes the above problems into consideration, and according to a first embodiment of the present disclosure, there is provided a charge control device that includes a current acquisition unit that acquires a charge current value of each battery, and a main charge unit that performs a main charge for each battery based on the charge current value acquired by the current acquisition unit.

According to a second embodiment of the present disclosure, the charge control device described in the first embodiment is configured that the main charge unit may perform the main charge for each battery in the order of from the highest charge current value.

In a system including an electronic device, a power source feeding power to the electronic device, and a plurality of batteries connected to the electronic device as illustrated in FIG. 26, for example, the present disclosure is used by the electronic device for controlling charging of the plurality of batteries using the current fed from the power source. The electronic device as a charge control device ascertains charge currents by charging each of the batteries for a few seconds. Then, the device performs charging in the order of batteries having higher charge current values obtained in the test charge. The time taken to fully charge all of the batteries is not affected by the order of charging, but when charging is stopped before all of the batteries are fully charged, the charge current integrated value, that is, the total charge amount of the batteries is great, which is efficient.

According to a third embodiment of the present disclosure, the charge control device described in the first embodiment is configured that, after a battery selected for the main charge based on a charge current value is fully charged, the main charge unit may perform the main charge for a remaining battery based on a charge current value.

According to a fourth embodiment of the present disclosure, the charge control device described in the first embodiment is configured that the current acquisition unit may acquire each of the charge current values by performing the test charge for each battery only for a short period of time.

According to a fifth embodiment of the present disclosure, the charge control device described in the first embodiment is configured to be an electronic device using discharged currents from each battery as a power source.

According to a sixth embodiment of the present disclosure, the charge control device described in the first embodiment is configured that, the main charge unit may switch a battery to be charged when the charge current value of a battery being charged decreases and becomes lower than the current value acquired from a battery not being charged by a fixed value or higher.

According to a seventh embodiment of the present disclosure, the charge control device described in the first embodiment is configured that the main charge unit may switch a battery to be charged when the charge current value of a battery being charged decreases, and becomes lower than the current value acquired from a battery not being charged, and then a fixed period of time elapses.

According to an eighth embodiment of the present disclosure, the charge control device described in the first embodiment further includes a voltage acquisition unit that acquires a voltage value of each battery. In addition, when the difference between the charge current values of each battery acquired by the current acquisition unit is equal to or lower than a fixed value, the main charge unit may perform the main charge in the order of batteries having lower voltage values acquired by the voltage acquisition unit.

According to a ninth embodiment of the present disclosure, the charge control device described in the first embodiment further includes a temperature acquisition unit that acquires the temperature of each battery. In addition, the main charge unit may perform the main charge for each battery in the order of from the highest charge current value, excluding a battery of which the temperature acquired by the temperature acquisition unit exceeds a reference value.

According to a tenth embodiment of the present disclosure, the charge control device described in the first embodiment further includes a full-charge capacity acquisition unit that acquires the full-charge capacity of each battery. In addition, when the difference between the charge current values of batteries acquired by the current acquisition unit is equal to or lower than a fixed value, the main charge unit may perform the main charge in the order of batteries having larger full-charge capacities acquired by the full-charge capacity acquisition unit.

According to an eleventh embodiment of the present disclosure, the charge control device described in the first embodiment further includes a number of charging and discharging times acquisition unit that acquires the number of charging and discharging times of each battery. In addition, when the difference between the charge current values of batteries acquired by the current acquisition unit is equal to or lower than a fixed value, the main charge unit may perform the main charge in the order of batteries having the fewer number of charging and discharging times acquired by the number of charging and discharging times acquisition unit.

Further, according to a twelfth embodiment of the present disclosure, there is provided a charge control method that includes a current acquisition step of acquiring a charge current value of each battery and a main charge step of performing a main charge for each battery based on the charge current value acquired in the acquiring.

According to the present disclosure, it is possible to provide an excellent charge control device and an excellent charge control method which can charge a plurality of secondary batteries in an appropriate order with high efficiency.

In addition, according to the present disclosure, it is possible to provide an excellent charge control device and charge control method which can charge a plurality of secondary batteries having various amounts of charge, temperature states, degree of deterioration, and number of battery cells connected in parallel in an appropriate order with high efficiency.

Other objectives, features and advantages of the present disclosure may be clarified by embodiments to be described later and detailed description based on accompanying drawings.

### BRIEF DESCRIPTION OF THE DRAWINGS

FIG. 1 is a diagram illustrating a configuration example of a digital single-lens reflex camera with a vertical position grip according to an embodiment of the present disclosure;

FIG. 2 is a diagram illustrating a form of using the digital camera with the vertical position grip illustrated in FIG. 1 according to the embodiment of the present disclosure;

FIG. 3A is a block diagram of an electric circuit of a charge system which includes a USB charger, the main body of the digital camera, the vertical position grip, and batteries according to the embodiment of the present disclosure;

FIG. 3B is a block diagram of the electronic circuit of the charge system which includes the USB charger, the main body of the digital camera, the vertical position grip, and the batteries according to the embodiment of the present disclosure;

FIG. 4 is a communication circuit diagram between the digital camera and the battery “1” and the battery “2” according to the embodiment of the present disclosure;

FIG. 5 is a timing chart of when communication is performed between a control unit of the main body of the digital camera and a microcomputer of the battery “1” according to the embodiment of the present disclosure;

FIG. 6 is a diagram illustrating the content of communication data exchanged between the control unit of the main body of the digital camera and the microcomputer of the battery “1” according to the embodiment of the present disclosure;

FIG. 7A is a flowchart describing a procedure of charge control performed by the control unit of the main body of the digital camera according to a first embodiment of the present disclosure;

FIG. 7B is a timing chart exemplifying the performance of charge control for a battery “1” and a battery “2” that are in different states according to the procedure illustrated in FIG. 7A according to the first embodiment of the present disclosure;

FIG. 8 is a flowchart describing a procedure of basic charge control for a battery according to the first embodiment of the present disclosure;

FIG. 9 is a diagram illustrating a charge characteristic of a lithium-ion battery according to the first embodiment of the present disclosure;

FIG. 10 is a diagram illustrating a temperature characteristic of the lithium-ion battery according to the first embodiment of the present disclosure;

FIG. 11 is a diagram illustrating the effect of deterioration of the battery exerted on the charge characteristic of the lithium-ion battery according to the first embodiment of the present disclosure;

FIG. 12 is a diagram illustrating the effect of a battery capacity exerted on the charge characteristic of the lithium-ion battery according to the first embodiment of the present disclosure;

FIG. 13 is a diagram illustrating the effect of the number of parallel cells exerted on the charge characteristic of the lithium-ion battery according to the first embodiment of the present disclosure;

FIG. 14A is a diagram illustrating a charge characteristic of the lithium-ion battery under temperature restriction according to the first embodiment of the present disclosure;

FIG. 14B is a timing chart illustrating the performance of charge control for the battery “1” under a valid temperature restriction and the battery “2” under an invalid temperature restriction according to the procedure illustrated in FIG. 14A according to the first embodiment of the present disclosure;

FIG. 15A is a flowchart describing a procedure of charge control by the control unit of the main body of the digital camera for an arbitrary number of batteries according to a third embodiment of the present disclosure;

FIG. 15B is a timing chart illustrating the performance of charge control for three batteries of the battery “1”, battery “2”, and battery “3” according to the procedure illustrated in FIG. 15A according to the third embodiment of the present disclosure;

FIG. 16A is a flowchart describing a procedure of charge control by the control unit of the main body of the digital camera according to a sixth embodiment of the present disclosure;

FIG. 16B is a timing chart exemplifying the performance of charge control for the battery “1” and the battery “2” which are in different states according to the procedure illustrated in FIG. 16A according to the sixth embodiment of the present disclosure;

FIG. 17A is a flowchart describing a procedure of charge control by the control unit of the main body of the digital camera for an arbitrary number of batteries according to the sixth embodiment of the present disclosure;

FIG. 17B is a timing chart illustrating the performance of charge control for three batteries of the battery “1”, battery “2”, and battery “3” according to the procedure illustrated in FIG. 17A according to the sixth embodiment of the present disclosure;

FIG. 18A is a flowchart describing the procedure of charge control by the control unit of the main body of the digital camera according to a seventh embodiment of the present disclosure;

FIG. 18B is a timing chart exemplifying the performance of charge control for the battery “1” and the battery “2” which are in different states according to the procedure illustrated in FIG. 18A according to the seventh embodiment of the present disclosure;

FIG. 19A is a flowchart describing a procedure of charge control by the control unit of the main body of the digital camera for an arbitrary number of batteries according to the seventh embodiment of the present disclosure;

FIG. 19B is a timing chart illustrating the performance of charge control for three batteries of the battery “1”, battery “2”, and battery “3” according to the procedure illustrated in FIG. 19A according to the seventh embodiment of the present disclosure;

FIG. 20 is a diagram showing a charge characteristic of a lithium-ion battery according to an eighth embodiment of the present disclosure;

FIG. 21 is a flowchart describing a procedure of charge control by the control unit of the main body of the digital camera according to the eighth embodiment of the present disclosure;

FIG. 22 is a diagram showing a charge characteristic of the lithium-ion battery according to a ninth embodiment of the present disclosure;

FIG. 23 is a flowchart describing a procedure of charge control by the control unit of the main body of the digital camera according to the ninth embodiment of the present disclosure;

FIG. 24 is a flowchart describing a procedure of charge control by the control unit of the main body of the digital camera according to an eleventh embodiment of the present disclosure;

FIG. 25 is a flowchart describing still another procedure of charge control by the control unit of the main body of the digital camera according to a twelfth embodiment of the present disclosure; and

FIG. 26 is a diagram illustrating a system configuration according to another embodiment of the present disclosure.

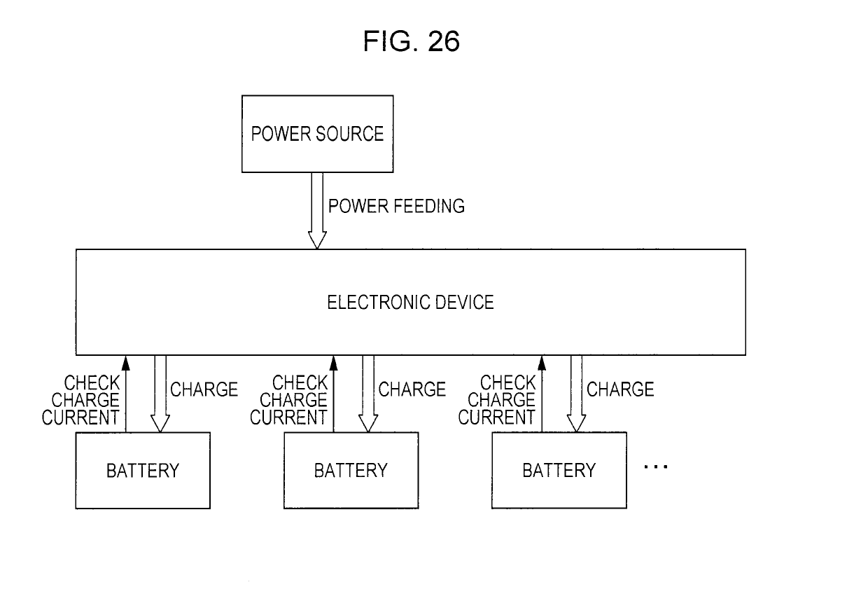

### DETAILED DESCRIPTION OF EMBODIMENTS

Hereinafter, embodiments of the present disclosure will be described in detail with reference to drawings.

A method for efficiently charging a battery for a device such as, for example, a digital camera assumed to be used in an outdoor place where a commercial power source is not provided so that rapid charging is difficult has been demanded. In addition, in order to drive a device for a long period of time even in a place where it is difficult to charge the device, it is also possible to connect the device to an extensible battery from outside, in addition to include another battery therein. In a digital single-lens reflex camera, there is a case in which vertical position photographing is performed by turning the main body of the camera to the side almost by 90 degrees during capturing of a person, but if the method of holding is unfamiliar, it is difficult to hold the camera and the hands are likely to shake during an operation of a shutter. A “vertical position grip” is an accessory provided on the bottom of the main body of a single-lens camera, is equipped with a shutter button, a control dial, and the like for vertical position capturing, and enables vertical position capturing with a natural posture without causing the wrist to be bent even when the main body of the camera is turned to the side by 90 degrees. Most vertical position grips can accommodate a plurality of batteries.

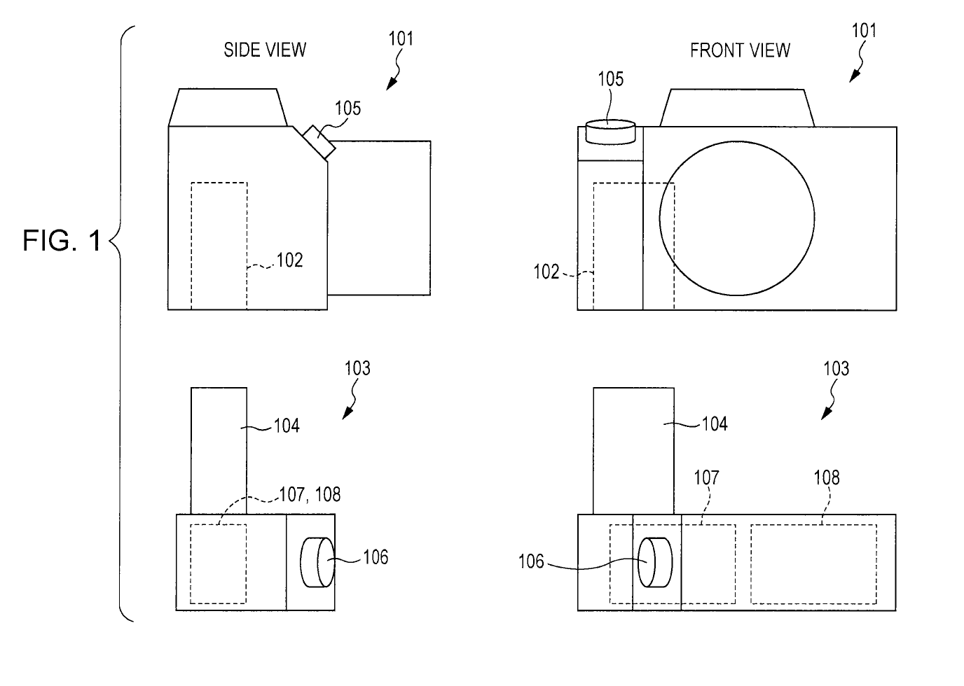

FIG. 1 illustrates a configuration example of a digital single-lens reflex camera with a vertical position grip according to an embodiment of the present disclosure.

The main body of the digital camera 101 is provided with a battery folder 102. Generally, a battery (not shown) is inserted into the battery folder 102 so as to cause the main body of the digital camera 101 to be operated by the electric power of the battery. On the other hand, in the example illustrated in the drawing, a coupling portion 104 of a vertical position grip 103 is inserted into the battery folder 102 so as to be connected to the main body of the digital camera 101. If the vertical position grip 103 is connected to the main body of the digital camera 101, capturing is possible even by pressing a shutter button 106 of the vertical position grip 103, in addition to a shutter button 105 of the main body of the digital camera 101. When capturing is performed using the shutter button 106 of the vertical position grip 103 by setting the main body of the digital camera 101 in a vertical position, the camera is stable and capturing is easy.

The vertical position grip 103 is provided with two battery folders 107 and 108. When the vertical position grip 103 is used in connection with the main body of the digital camera 101, electric power from two batteries inserted in the battery folders 107 and 108 is supplied to the main body of the digital camera 101 via the coupling portion 104 and the battery folder 102 on the main body of the digital camera 101 side so as to operate the main body of the digital camera 101.

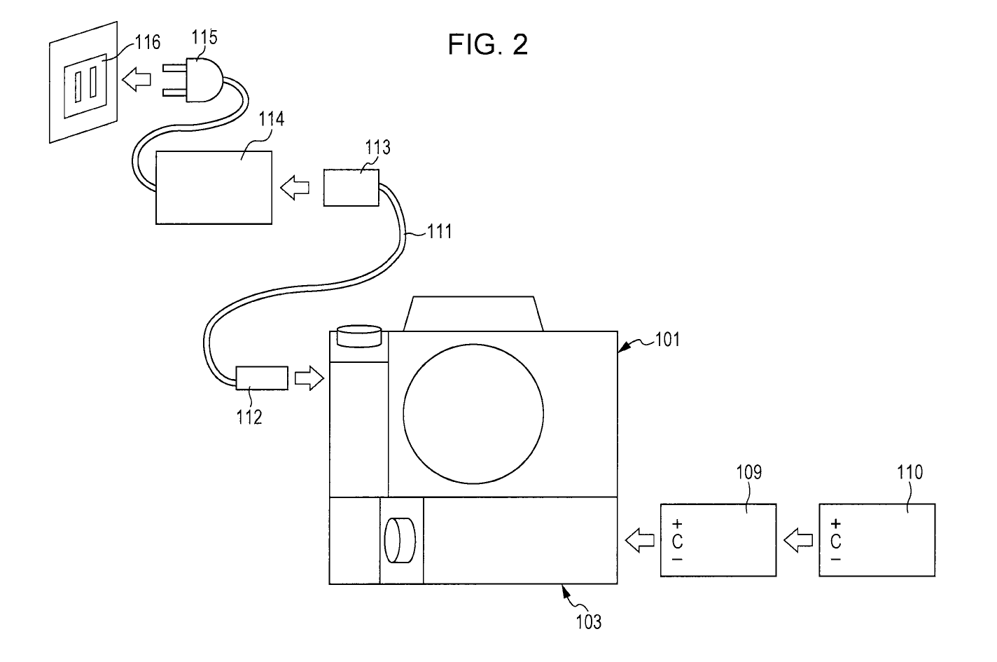

FIG. 2 illustrates a form of using the digital camera 101 with the vertical position grip 103 illustrated in FIG. 1 according to the embodiment of the present disclosure.

The main body of the digital camera 101 is connected to the vertical position grip 103. In the battery folders 107 and 108 of the vertical position grip 103, a battery “1” 109 and a battery “2” 110 are respectively inserted. To be described later, charging is performed for the battery “1” 109 and the battery “2” 110 through charge control by the main body of the digital camera 101.

On the other hand, the main body of the digital camera 101 is connected to a terminal 112 of a USB cable 111 on the device side. In addition, a terminal 113 of the USB cable 111 on the host side is connected to a USB charger 114. To the USB charger 114, an AC plug 115 is attached so as to be connected to a commercial electric power socket 116. Electric power for charging the battery “1” 109 and the battery “2” 110 is supplied to the main body of the digital camera 101 via the USB cable 111 and the USB charger 114 from the commercial electric power socket 116.

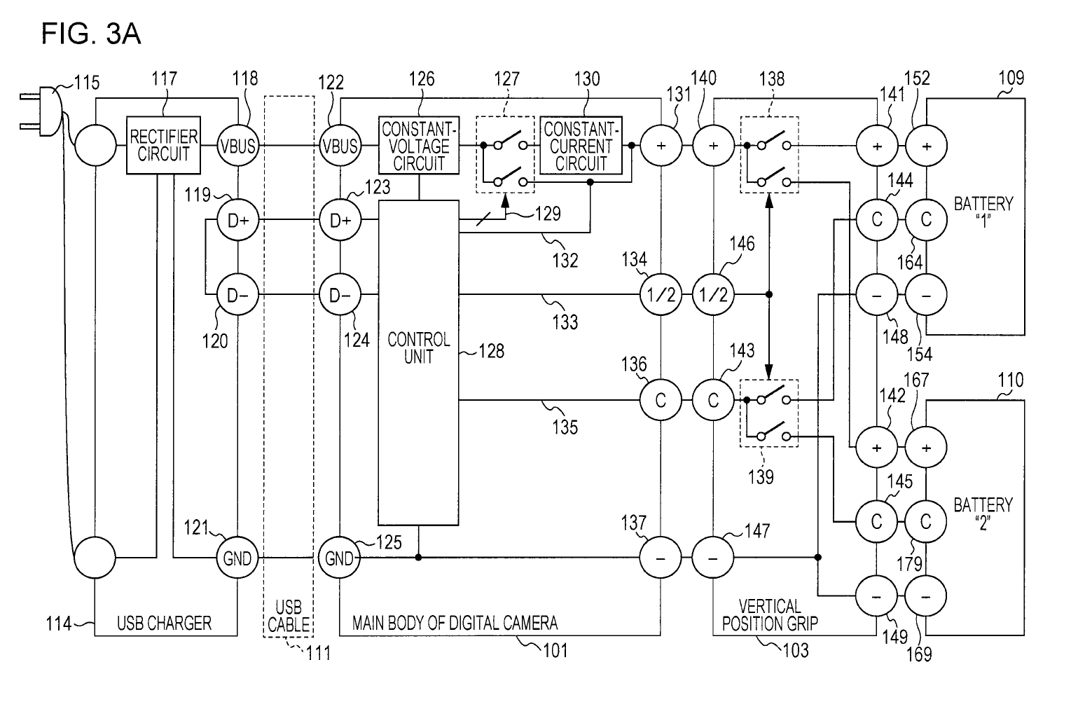

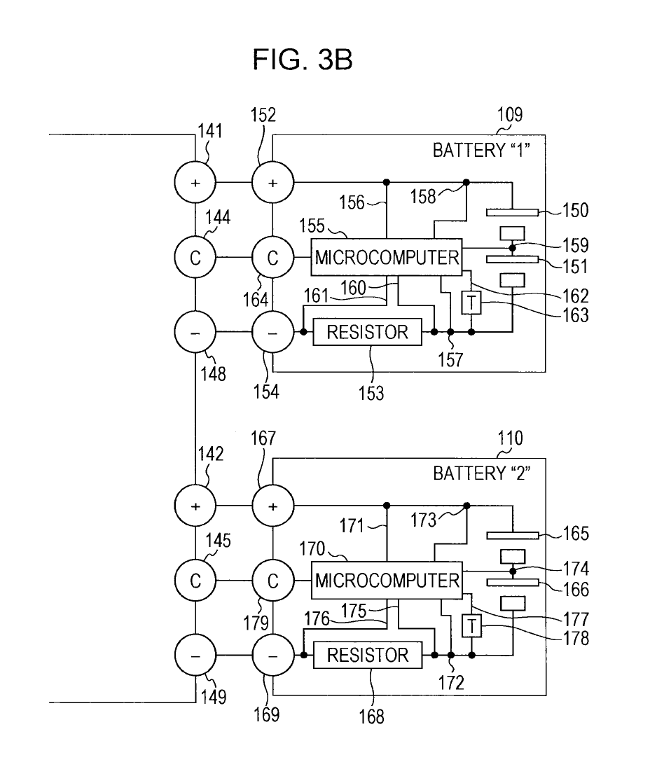

FIG. 3A and FIG. 3B illustrate block diagrams of an electric circuit of a charge system which includes the USB charger 114, the main body of the digital camera 101, the vertical position grip 103, and the batteries “1” 109 and “2” 110 illustrated in FIG. 2 according to the embodiment of the present disclosure.

Inside the USB charger 114, a current with AC 100 V supplied from the AC plug 115 is converted to DC 5 V by a rectifier circuit 117.

The DC 5 V converted in the rectifier circuit 117 is output to a VBUS terminal 118 of the USB cable 111. A D+ terminal 119 and a D− terminal 120 of the USB cable 111 are short-circuited inside the USB charger 114. A GND terminal 121 of the USB cable 111 is connected to a GND level of the rectifier circuit 117.

Inside the main body of the digital camera 101, the DC 5 V supplied from the VBUS terminal 122 is converted into DC 8.4 V by a constant-voltage circuit 126 and then output to a switch 127. In addition, the supplied DC 5 V is converted into DC 3 V by the constant-voltage circuit 126 and then supplied to a control unit 128 including a microcomputer, and the like.

The control unit 128 checks whether sufficient currents can be supplied from the VBUS terminal 122. At this moment, if a resistance value between the D+ terminal and the D− terminal is equal to or lower than 220Ω based on a USB standard, a terminal that is determined to supply a sufficient current of 1.5 A is used. An input and output port of the control unit 128 is connected to the D+ terminal 123 and the D− terminal 124. When an input to the D− terminal 124 is High when High is output to the D+ terminal 123 and an input to the D− terminal 124 is Low when Low is output to the D+ terminal 123, the control unit 128 determines that sufficient current can be supplied from the VBUS terminal 122 and then starts charge control.

The control unit 128 controls the switch 127 to be on and off using a signal line 129. The switch 127 performs switching for the DC 8.4 V output from the constant-voltage circuit 126 so as to be output to a + terminal 131 via another constant-current circuit 130 or to be directly output to the + terminal 131. The constant-current circuit 130 is a circuit that regulates charge current not to flow with 100 mA or higher.

The control unit 128 can measure a voltage at the + terminal 131 using an AD port 132.

The control unit 128 outputs a switching signal 133 for switching charge of either of the battery “1” 109 or the battery “2” 110. The switching signal 133 is output from a ½ terminal 134 to the vertical position grip 103.

The control unit 128 performs communication with the battery “1” 109 or the battery “2” 110 using a signal line 135. The signal line 135 is connected to a C terminal 136.

The control unit 128 causes a GND terminal 125 on the USB side to be a GND level. In addition, the GND terminal 125 is also connected to − terminal 137 on the battery side.

Inside the vertical position grip 103, switches 138 and 139 are disposed.

The switch 138 switches the supply of a current from a + terminal 140 to either of the battery “1” 109 or the battery “2” 110. When the current is supplied to the battery “1” 109, the + terminal 140 and the + terminal 141 are connected. In addition, when the current is supplied to the battery “2” 110, the + terminal 140 and another + terminal 142 are connected.

The switch 139 switches communication of the control unit 128 to either of the battery “1” 109 or the battery “2” 110. When the control unit 128 performs communication with the battery “1” 109, a C terminal 143 and another C terminal 144 are connected. In addition, when the control unit 128 performs communication with the battery “2” 110, the C terminal 143 and another C terminal 145 are connected.

The switches 138 and 139 performs switching of connection to either of the battery “1” 109 and the battery “2” 110 based on a switching signal from a ½ terminal 146.

A − terminal 147 is directly connected to a − terminal 148 on the battery “1” 109 side and a − terminal 149 on the battery “2” 110 side.

Inside the battery “1” 109, two battery cells 150 and 151 are connected in series. The positive pole of the battery cell 150 is connected to a + terminal 152 and the negative pole of the battery cell 151 is connected to a -terminal 154 via a resistor 153 for current detection.

The battery “1” 109 includes a microcomputer 155. The microcomputer 155 receives power feeding 156 from the positive pole of the battery cell 150 and holds a GND 157 from the negative pole of the battery cell 151.

The microcomputer 155 measures a total voltage of the battery cells 150 and 151 using an AD port 158, and measures an intermediate voltage between the battery cells 150 and 151 using another AD port 159.

In addition, after the microcomputer 155 measures voltages (potential difference) of both ends of the current detection resistor 153 using AD ports 160 and 161, the microcomputer calculates a charge current flowing to the battery cells 150 and 151 by dividing the measured potential difference by a resistance value of the current detection resistor 153.

In addition, the microcomputer 155 measures a battery voltage of one side of a thermistor 163 using an AD port 162. The terminal on the other side of the thermistor 163 is connected to the GND 157. The AD port 162 is pulled up to a reference voltage by a fixed resistor (not shown) inside the microcomputer 155. Thus, the voltage measured by the AD port 162 is changed due to the temperature inside the battery 109. The microcomputer 155 stores a table describing the relationship between the temperature and the voltage measured by the AD port 162 in advance, and obtains the temperature based on the voltage measured by the AD port 162.

Then, the microcomputer 155 can output information on the temperature, current, and voltage measured as described above as data from a C terminal 164.

On the other hand, inside the battery “2” 110, two battery cells 165 and 166 are connected in series. The positive pole of the battery cell 165 is connected to a + terminal 167 and the negative pole of the battery cell 166 is connected to a − terminal 169 via a resistor 168 for current detection.

The battery “2” 110 includes a microcomputer 170. The microcomputer 170 receives power feeding 171 from the positive pole of the battery cell 165 and holds a GND 172 from the negative pole of the battery cell 166.

The microcomputer 170 measures a total voltage of the battery cells 165 and 166 using an AD port 173, and measures an intermediate voltage between the battery cells 165 and 166 using another AD port 174.

In addition, after the microcomputer 170 measures voltages (potential difference) of both ends of the current detection resistor 168 using AD ports 175 and 176, the microcomputer calculates a charge current flowing to the battery cells 165 and 166 by dividing the measured potential difference by a resistance value of the current detection resistor 168.

In addition, the microcomputer 170 measures a battery voltage of one side of a thermistor 178 using an AD port 177. The terminal on the other side of the thermistor 178 is connected to the GND 172. The AD port 177 is pulled up to a reference voltage by a fixed resistor (not shown) inside the microcomputer 170. Thus, the voltage measured by the AD port 177 is changed due to the temperature inside the battery 110. The microcomputer 170 stores a table describing the relationship between the temperature and the voltage measured by the AD port 177 in advance, and obtains the temperature based on the voltage measured by the AD port 177.

Then, the microcomputer 170 can output information on the temperature, current, and voltage measured as described above as data from a C terminal 179.

The AC plug 115 is connected to the commercial power source socket 116 when in use. In addition, the VBUS terminal 118, D+ terminal 119, D− terminal 120, and GND terminal 121 of the USB charger 114 are respectively connected to the VBUS terminal 122, D+ terminal 123, D− terminal 124 and GND terminal 125 on the main body of the digital camera 101 side using the USB cable 111. In addition, the main body of the digital camera 101 is connected to the vertical position grip 103, and the + terminal 131, ½ terminal 134, C terminal 136, and − terminal 137 on the main body of the digital camera 101 side are respectively connected to the + terminal 140, ½ terminal 146, C terminal 143 and − terminal 147 on the vertical position grip 103 side. Furthermore, the vertical position grip 103 is mounted with the battery “1” 109 and the battery “2” 110, the + terminal 141, C terminal 144 and − terminal 148 of the vertical position grip 103 are respectively connected to the + terminal 152, C terminal 164 and − terminal 154 of the battery “1” 109, and the + terminal 142, C terminal 145 and − terminal 149 of the vertical position grip 103 are respectively connected to the + terminal 167, C terminal 179 and − terminal 169 of the battery “2” 110.

Note that power feeding is not limited to supply from the USB charger 114 via the USB cable 111, and any form of power feeding may be possible if the feeding can supply a direct current with a constant voltage. Since electric power can be converted to a sufficiently optimal voltage by the constant-voltage circuit 126 of the main body of the digital camera 101, the technology disclosed in the present disclosure can be implemented for charging with a voltage other than 5 V of the USB standard.

In addition, the power source does not have to be a commercial power source. The power source may be an AC power source or a DC power source, and the technology disclosed in the present disclosure can be implemented if the power source can be converted to a constant voltage by the rectifier circuit in the USB charger 114. Of course, any source that can supply electric power, such as a hand generator, a generator driven by an internal combustion engine, a primary battery, a secondary battery, a solar battery, and other electronic devices, can be used as a power source instead of a commercial power source.

In addition, the batteries “1” and “2” are not limited to connection of two cells in series, and three or more cells may be connected in series even if each battery contains only one cell.

In addition, in the configuration example illustrated FIG. 3, the thermistors 163 and 178 are arranged inside the battery “1” and the battery “2” respectively in order to measure temperatures of the battery “1” and the battery “2”, but the thermistors can be configured to be installed outside the batteries. For example, thermistors are arranged in the respective battery folders 107 and 108 for the battery “1” and the battery “2” of the vertical position grip 103 so as to calculate temperatures of the thermistors by measuring voltage values of the respective thermistors using the AD port of the control unit 128 of the main body of the digital camera 101. In this case, the temperatures of the battery folders 107 and 108 obtained based on specific heat of a material and the location of the heat source can be converted to the temperatures of the batteries “1” and “2” based on a look-up table of the batteries “1” and “2”, and then current restrictions may be performed using the temperatures. Note that, when the configuration that the batteries “1” and “2” are directly inserted to the main body of the digital camera 101 without using the vertical position grip 103 is adopted, it is possible to perform the same temperature restriction process by installing thermistors in the respective battery folders (not shown) provided in the main body of the digital camera 101.

In addition, in the configuration example illustrated in FIG. 3, the resistors 153 and 168 for measuring the charge currents of the batteries “1” and “2” are arranged inside the batteries “1” and “2” respectively, but can be configured to be attached outside the batteries. For example, the resistors 153 and 168 may be connected to the GND line of the vertical position grip 103 in series. In this case, a charge current is obtained in such a way that the voltages of both ends of the resistors 153 and 168 are measured by the AD port of the control unit 128 of the main body of the digital camera 101, and the measured potential difference is divided by the resistance values of the resistors 153 and 168 so as to be used in charge control to be described later.

Alternatively, the resistors 153 and 168 may be connected to the GND line of the main body of the digital camera 101 in series. Also in this case, a charge current is obtained in such a way that the voltages of the both ends of the resistors 153 and 168 are measured by the AD port of the control unit 128 of the main body of the digital camera 101, and the measured potential difference is divided by the resistance values of the resistors 153 and 168 so as to be used in the charge control to be described later.

In addition, in the configuration example illustrated in FIG. 3, the switches 138 and 139 for switching charging of the battery “1” or the battery “2” are arranged inside the vertical position grip 103, but the switches 138 and 139 can also be configured to be arranged in the main body of the digital camera 101.

In addition, in the configuration example illustrated in FIG. 3, the constant-current circuit 130 for regulating a charge current (for satisfying “Premise 1” described above) is arranged inside the main body of the digital camera 101, but constant-current circuits may be respectively arranged inside each of the batteries “1” and “2”. In this case, the microcomputer 155 inside the battery “1” 109 causes the AD ports 158 and 159 to measure the battery voltage, and when the cell voltage is lower than the threshold value, the microcomputer causes the constant-current circuit to operate so as to perform a constant power charge for the cells 150 and 151. In the same manner, the microcomputer 170 inside the battery “2” 110 causes the AD ports 173 and 174 to measure the battery voltage, and when the cell voltage is lower than the threshold value, the microcomputer causes the constant-current circuit to operate so as to perform a constant power charge for the cells 165 and 166.

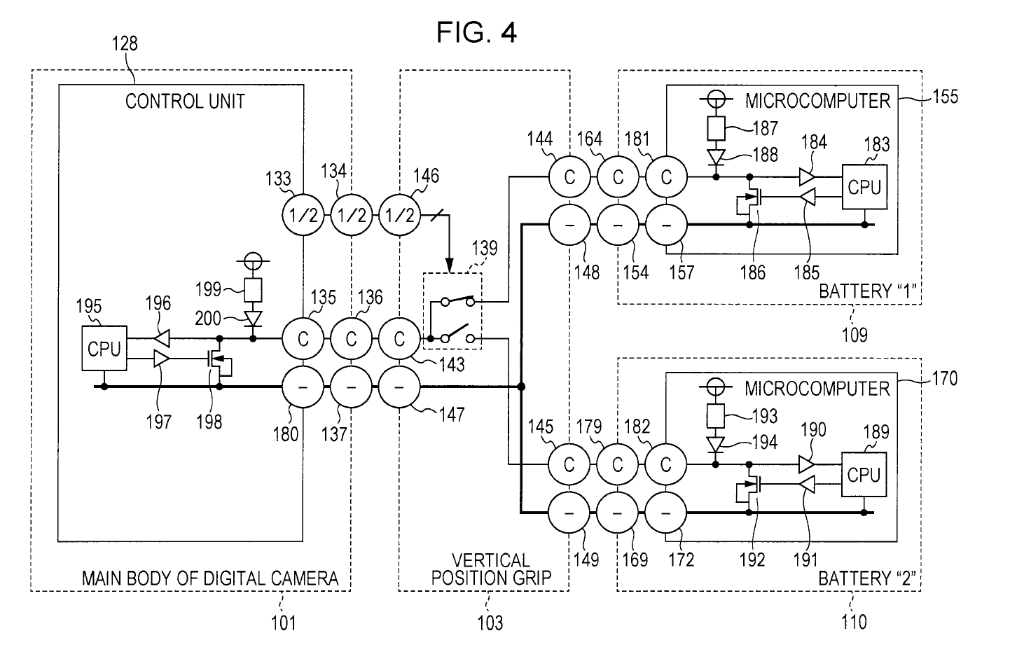

FIG. 4 is a communication circuit diagram between the digital camera 101 and the battery “1” 109 and the battery “2” 110 according to the embodiment of the present disclosure.

The GND 157 of the microcomputer 155 of the battery “1” 109 is connected to a GND 180 of the control unit 128 of the main body of the digital camera 101 via the − terminal 154 of the battery “1” 109, the − terminal 148 of the vertical position grip, and the − terminal 137 of the main body of the digital camera 101.

An input and output port 181 of the microcomputer 155 of the battery “1” 109 is connected to the input and output port 135 of the control unit 128 of the main body of the digital camera 101 via the C terminal 164 of the battery “1” 109, the C terminal 144, the switch 139, and the C terminal 143 of the vertical position grip 103, and the C terminal 136 of the main body of the digital camera 101.

The GND 172 of the microcomputer 170 of the battery “2” 110 is connected to the GND 180 of the control unit 128 of the main body of the digital camera 101 via the − terminal 169 of the battery “2” 110, the − terminal 149 of the vertical position grip 103, and the − terminal 137 of the main body of the digital camera 101.

An input and output port 182 of the microcomputer 170 of the battery “2” 110 is connected to the input and output port 135 of the control unit 128 of the main body of the digital camera 101 via the C terminal 179 of the battery “2” 110, the C terminal 145, the switch 139, and the C terminal 143 of the vertical position grip 103, and the C terminal 136 of the main body of the digital camera 101.

The microcomputer 155 of the battery “1” 109 includes a CPU (Central Processing Unit) 183, an input buffer 184, an output buffer 185, an output FET (Field Effect Transistor) 186, a pull-up resistor 187, and a pull-up diode 188.

When it is desired to output a low level signal to the C terminal 164 of the battery “1” 109, the microcomputer 155 of the battery “1” 109 outputs a high level signal using the output buffer 185. Then, the output FET 186 is turned on, the input and output port 181 turns to a low level signal, and the C terminal 164 turns to a low level signal.

In addition, when the microcomputer 155 of the battery “1” 109 desires to output a high level signal to the C terminal 164 of the battery “1” 109, the microcomputer outputs a low level signal using the output buffer 185. Then, the output FET 186 is turned off, the input and output port 181 turns to a high level signal, and then the C terminal 164 turns to a high level signal.

In addition, when the microcomputer 155 of the battery “1” 109 desires to know whether the C terminal 164 of the battery “1” 109 is a high level or a low level signal, the microcomputer can obtain the information through the input buffer 184.

The microcomputer 170 of the battery “2” 110 includes a CPU 189, an input buffer 190, an output buffer 191, an output FET 192, a pull-up resistor 193, and a pull-up diode 194.

When it is desired to output a low level signal to the C terminal 179 of the battery “2” 110, the microcomputer 170 of the battery “2” 110 outputs a high level signal using the output buffer 191. Then, the output FET 192 is turned on, the input and output port 182 turns to a low level signal, and then the C terminal 179 turns to a low level signal.

In addition, when the microcomputer 170 of the battery “2” 110 desires to output a high level signal to the C terminal 179 of the battery “2” 110, the microcomputer outputs a low level signal using the output buffer 191. Then, the output FET 192 is turned off, the input and output port 182 turns to a high level signal, and then the C terminal 179 turns to a high level signal.

In addition, when the microcomputer 170 of the battery “2” 110 desires to know whether the C terminal 179 of the battery “2” 110 is a high level or a low level signal, the microcomputer can obtain the information from the input buffer 190.

The control unit 128 of the main body of the digital camera 101 includes a CPU 195, an input buffer 196, an output buffer 197, an output FET 198, a pull-up resistor 199, and a pull-up diode 200.

When the control unit 128 desires to output a low level signal to the C terminal 136 of the main body of the digital camera 101, the control unit outputs a high level signal using the output buffer 197. Then, the output FET 198 is turned on, the input and output port 135 turns to a low level signal, and then the C terminal 136 turns to a low level signal.

In addition, when the control unit 128 desires to output a high level signal to the C terminal 136 of the main body of the digital camera 101, the control unit outputs a low level signal using the output buffer 197. Then, the output FET 198 is turned on, the input and output port 135 turns to a high level signal, and then the C terminal 136 turns to a high level signal.

In addition, when the control unit 128 desires to know whether the C terminal 136 of the main body of the digital camera 101 is a high level or a low level signal, the control unit can obtain the information from the input buffer 196.

The output port 133 of the control unit 128 is connected to the switch 139 via the ½ terminal 134 of the main body of the digital camera 101, and the ½ terminal 146 of the vertical position grip 103.

On the main body of the digital camera 101 side, the control unit 128 can communicate with the microcomputer 155 of the battery “1” 109 by controlling the output port 133 so that the switch 139 attains “connection of the C terminals 143 and 144 and disconnection of the C terminals 143 and 145”. In addition, the control unit 128 can communicate with the microcomputer 170 of the battery “2” 110 by controlling the output port 133 so that the switch 139 attains “disconnection of the C terminals 143 and 144 and connection of the C terminals 143 and 145”.

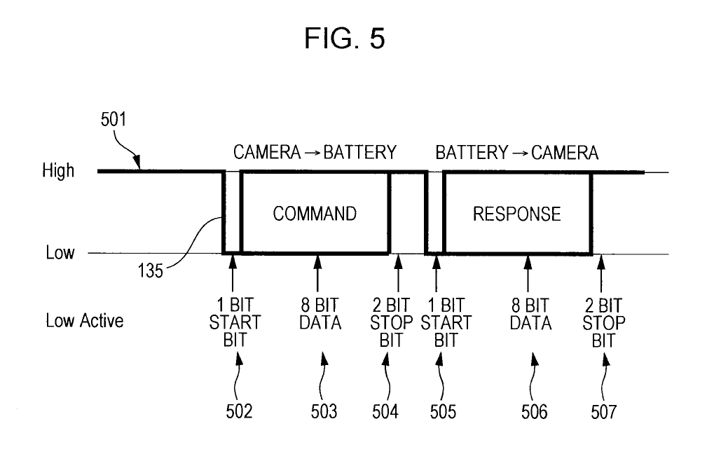

FIG. 5 illustrates a timing chart of when communication is performed between the control unit 128 on the main body of the digital camera 101 side and the microcomputer 155 of the battery “1” 109 according to the embodiment of the present disclosure. However, it is assumed that the control unit 128 of the main body of the digital camera 101 communicates with the microcomputer 155 of the battery “1” 109 by setting the switch 139 to attain “connection of the C terminals 143 and 144 and disconnection of the C terminals 143 and 145”. In addition, a signal is set to be driven in a low active state.

Before the communication is started, the output FET 186 of the battery “1” 109 and the output FET 198 of the main body of the digital camera 101 are turned off together. At this moment, the signal line 135 that is a communication line is a high level signal as indicated by reference numeral 501.

At the start of the communication, the control unit 128 of the main body of the digital camera 101 turns on the output FET 198 for the time equivalent to 1 bit of communication data so that the communication line is a low level signal as indicated by reference numeral 502. The control unit 128 of the main body of the digital camera 101 and the microcomputer 155 of the battery “1” 109 synchronize the communication timing based on the low level section equivalent to 1 bit of the communication data.

Subsequently, the control unit 128 of the main body of the digital camera 101 transmits a command of which the length of 8 bits to the communication line as indicated by reference numeral 503. At this moment, the control unit 128 causes the output FET 198 to be turned off for the bits of a high output and on for the bits of a low output.

In regard to this operation, the microcomputer 155 of the battery “1” 109 receives the command, that is, a high level/low level signal of the communication line through the input buffer 184.

Subsequently, the control unit 128 of the main body of the digital camera 101 transmits a stop bit with a length of 2 bits to the communication line as indicated by reference numeral 504. The microcomputer 155 of the battery “1” 109 ascertains the completion of the communication based on the 2-bit stop bit.

Subsequently, the control unit 128 of the main body of the digital camera 101 turns on the output FET 198 for the time equivalent to 1 bit of communication data so that the communication line is a low level signal as indicated by reference numeral 505.

Subsequently, the microcomputer 155 of the battery “1” 109 transmits a response with a length of 8 bits to the communication line as indicated by reference numeral 506. At this moment, the microcomputer 155 of the battery “1” 109 causes the output FET 186 to be turned off for the bits of a high output and causes the output FET 186 to be turned on for the bits of a low output.

In regard to this operation, the control unit 128 of the main body of the digital camera 101 receives the response, that is, a high level/level signal of the communication line through the input buffer 196.

Subsequently, the control unit 128 of the main body of the digital camera 101 transmits a stop bit of with a length of 2 bits to the communication line as indicated by reference numeral 507. The microcomputer 155 of the battery “1” 109 ascertains the completion of the communication based on the 2-bit stop bit.

One round of communication is completed according to the series of events described above.

In addition, the control unit 128 of the main body of the digital camera 101 can communicate with the microcomputer 170 of the battery “2” 110 by setting the switch 139 to attain “disconnection of the C terminals 143 and 144 and connection of the C terminals 143 and 145”. The communication method of this case is the same as the method described above.

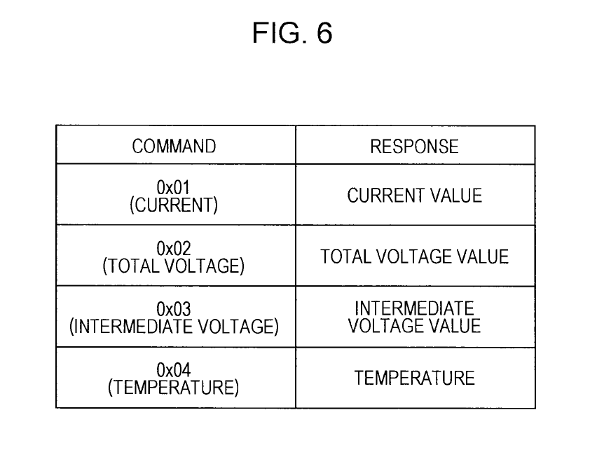

FIG. 6 summarizes the content of communication data exchanged between the control unit 128 of the main body of the digital camera 101 and the microcomputer 155 of the battery “1” 109 in the communication sequence illustrated in FIG. 5 according to the embodiment of the present disclosure.

When the control unit 128 of the main body of the digital camera 101 transmits a command “0x01” for requesting a current, the microcomputer 155 of the battery “1” 109 replies with a current value as a response.

In addition, when the control unit 128 of the main body of the digital camera 101 transmits a command “0x02” for requesting a total voltage, the microcomputer 155 of the battery “1” 109 replies with a total voltage value as a response.

In addition, when the control unit 128 of the main body of the digital camera 101 transmits a command “0x03” for requesting an intermediate voltage, the microcomputer 155 of the battery “1” 109 replies with an intermediate voltage value as a response.

In addition, when the control unit 128 of the main body of the digital camera 101 transmits a command “0x04” for requesting temperature, the microcomputer 155 of the battery “1” 109 replies with temperature as a response.

In addition, when the control unit 128 of the main body of the digital camera 101 can acquire the type IDs of the batteries from the battery “1” 109 and the battery “2” 110 and can also perform recognition communication with the battery “1” 109 and the battery “2” 110 by the communication method. The control unit 128 controls charging of the battery “1” 109 and the battery “2” 110 to be described later, but may exclude (or not charge) a battery of which the type ID indicates that the battery is not subject to charge control by the control unit 128 or a battery that is difficult to perform correct recognition communication from targets of the charge control.

### First Embodiment

The control unit 128 of the main body of the digital camera 101 controls charging of the battery “1” 109 and the battery “2” 110 that are inserted in the vertical position grip 103. Basically, a charge current is ascertained by performing a test charge for each battery for several seconds, and then the batteries are charged in the order from the highest charge current value obtained in the test charge. The time taken to fully charge all of the batteries is not affected by the charge order, but when charging is stopped before all of the batteries are fully charged, the charge current integrated value becomes great, and therefore, charging is efficiently controlled.

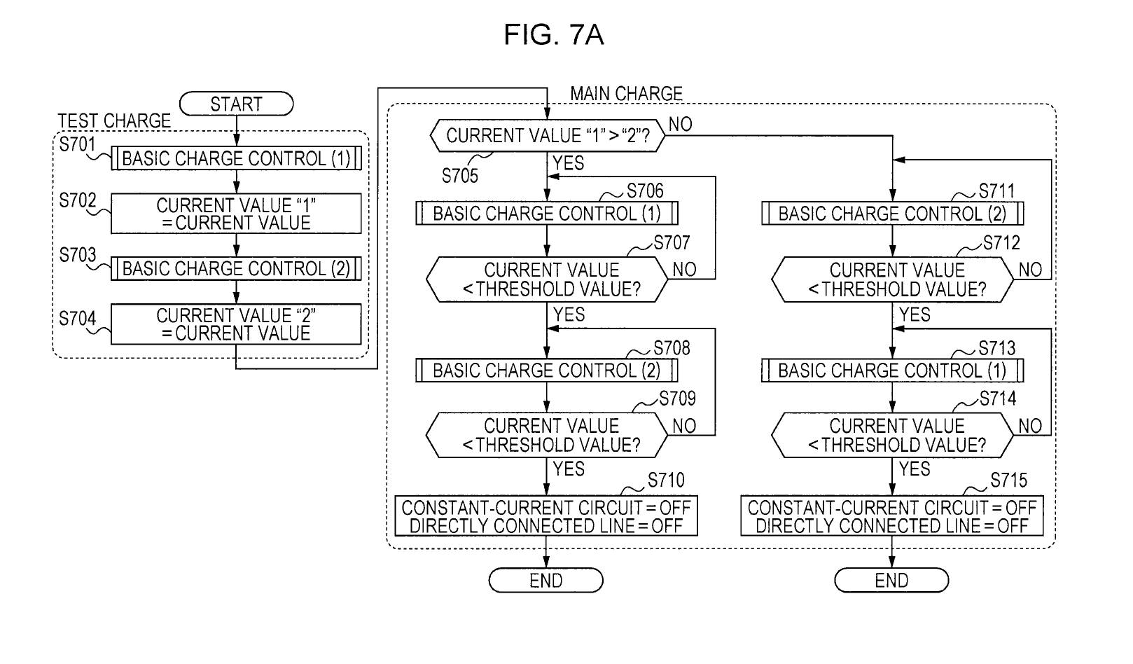

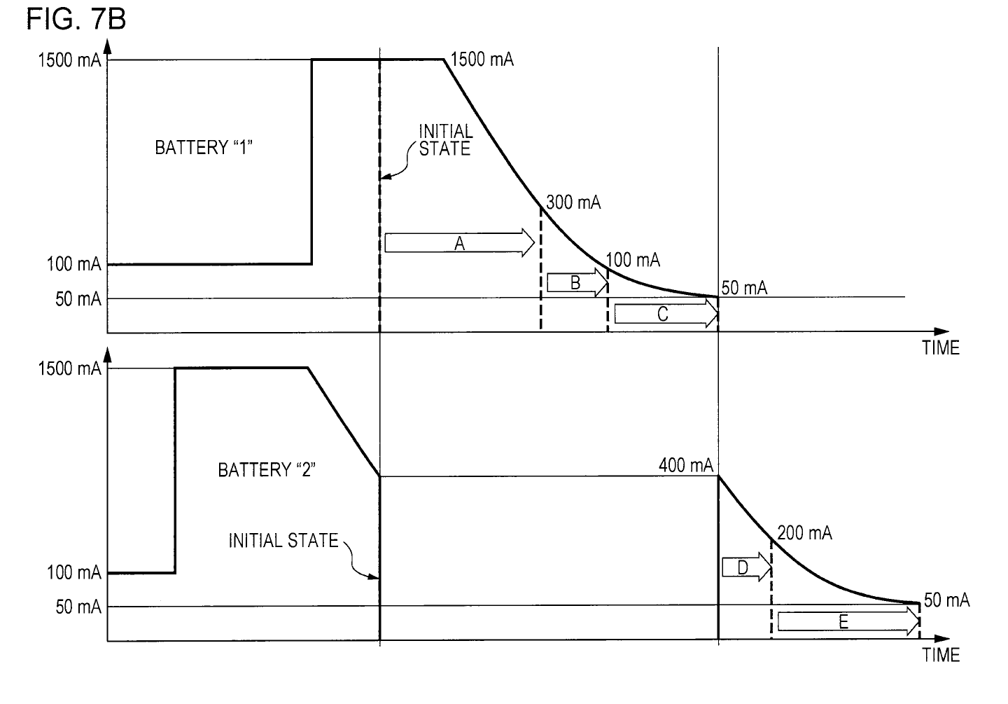

FIG. 7A illustrates a procedure of charge control performed by the control unit 128 of the main body of the digital camera 101 in the form of a flowchart according to a first embodiment of the present disclosure. As illustrated, charge control is performed from test charge to main charge in this order.

When charging is started, a basic charge control is first performed for the battery “1” 109 (Step S701), a charge current value “1” of the battery “1” 109 is acquired (Step S702), subsequently, basic charge control is performed for the battery “2” 110 (Step S703), and then a charge current value “2” of the battery “2” 110 is acquired (Step S704).

Thereby, the test charge ends, and then the main charge is started.

In the main charge, first, the sizes of the charge current value “1” of the battery “1” 109 and the charge current value “2” of the battery “2” 110 acquired in the test charge are compared (Step S705).

When the charge current value “1” of the battery “1” 109 acquired in the test charge is greater (Yes in Step S705), basic charge control for the battery “1” 109 is performed (Step S706). The basic charge control for the battery “1” 109 continues until charging of the battery “1” 109 proceeds, the potential difference between the battery voltage and the power source voltage for charging becomes small and thereby the charge current value is lower than a predetermined threshold value stored in the control unit 128 (No in Step S707).

Then, when charge current value of the battery “1” 109 is lower than the predetermined threshold value (Yes in Step S707), charging of the battery “1” 109 is determined to be completed, and subsequently, basic charge control for the battery “2” 110 is performed (Step S708). The basic charge control for the battery “2” 110 continues until charging of the battery “2” 110 proceeds, the potential difference between the battery voltage and the power source voltage for charging becomes small and thereby the charge current value is lower than the predetermined threshold value (No in Step S709).

Then, when the charge current value of the battery “2” 110 is lower than the predetermined threshold value (Yes in Step S709) and charging of both batteries is completed, the control unit 128 causes the switch 127 to be in the state of “disconnection on the constant-current circuit side and disconnection on the directly connected line side” using the signal line 129 (Step S710), and thereby the charge control is completed.

On the other hand, when the charge current value “2” of the battery “2” 110 acquired in the test charge is greater (No in Step S705), basic charge control for the battery “2” 110 is performed (Step S711). The basic charge control for the battery “2” 110 continues until charging of the battery “2” 110 proceeds, the potential difference between the battery voltage and the power source voltage for charging becomes small and thereby the charge current value is lower than the predetermined threshold value (No in Step S712).

Then, when charge current value of the battery “2” 110 is lower than the predetermined threshold value (Yes in Step S712), charging of the battery “2” 110 is determined to be completed, and subsequently, basic charge control for the battery “1” 109 is performed (Step S713). The basic charge control for the battery “1” 109 continues until charging of the battery “1” 109 proceeds, the potential difference between the battery voltage and the power source voltage for charging becomes small and thereby the charge current value is lower than the predetermined threshold value (No in Step S714).

Then, when the charge current value of the battery “1” 109 is lower than the predetermined threshold value (Yes in Step S714) and charging of both batteries is completed, the control unit 128 causes the switch 127 to be in the state of “disconnection on the constant-current circuit side and disconnection on the directly connected line side” using the signal line 129 (Step S715), and thereby the charge control is completed.

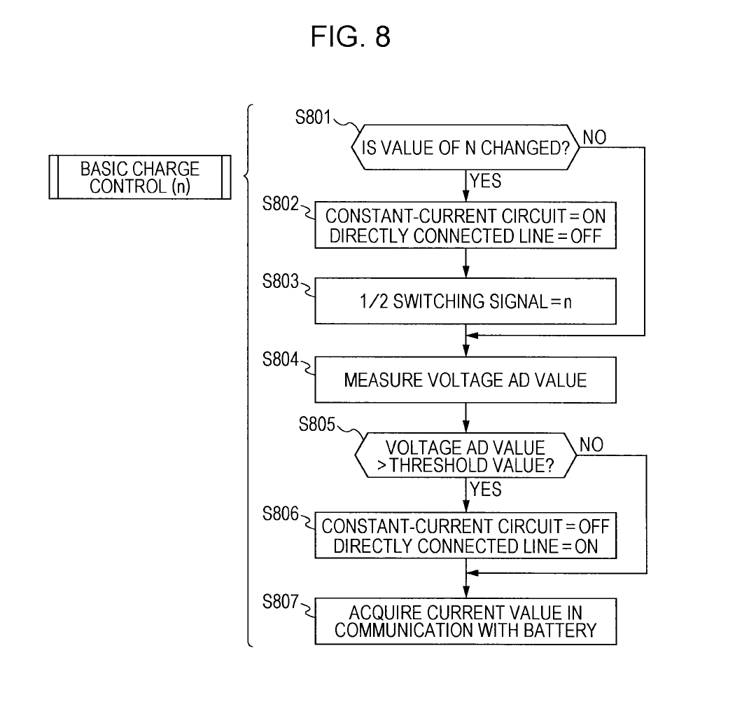

FIG. 8 shows a procedure of basic charge control for a battery in the form of a flowchart according to the first embodiment of the present disclosure. Herein, the argument n in the drawing indicates the ID of a battery to be subject to basic charge control, and n is 1 in the case of the battery “1” 109 and n is 2 in the case of the battery “2” 110.

When basic charge control is started, first, it is checked whether the value of n has been changed or not (Step S801). When the value of n has been changed (Yes in Step S801), in other words, when the battery to be subject to the basic charge control has been switched, the control unit 128 causes the switch 127 to be in the state of “connection on the constant-current circuit side and disconnection on the directly connected line side” using the signal line 129 (Step S802), and operates the switches 138 and 139 using the signal line 133 so as to switch the battery that will supply a charge current output from the constant-current circuit 130 (Step S803).

At this time, initial charging is performed for a battery “n” to be subject to basic charge control with a constant charge current of 100 mA.

The control unit 128 measures the voltage at the + terminal 131, that is, a charge voltage using the AD port 132 (Step S804). When the charge voltage is greater than a predetermined threshold stored in the control unit 128 (Yes in Step S805), the control unit 128 causes the switch 127 to be in the switched state of “disconnection on the constant-current circuit side and connection on the directly connected line side” (Step S806) so as to perform a constant voltage charge with 8.4 V output from the constant-voltage circuit 126. Otherwise, the control unit 128 does not change the state of “connection on the constant-current circuit side and disconnection on the directly connected line side” of the switch 127, and continues the constant current charge with 100 mA output from the constant-current circuit 130.

Finally, the control unit 128 acquires the charge current value for the battery “n” to be subject to the basic charge control using the input and output port 135 (Step S807).

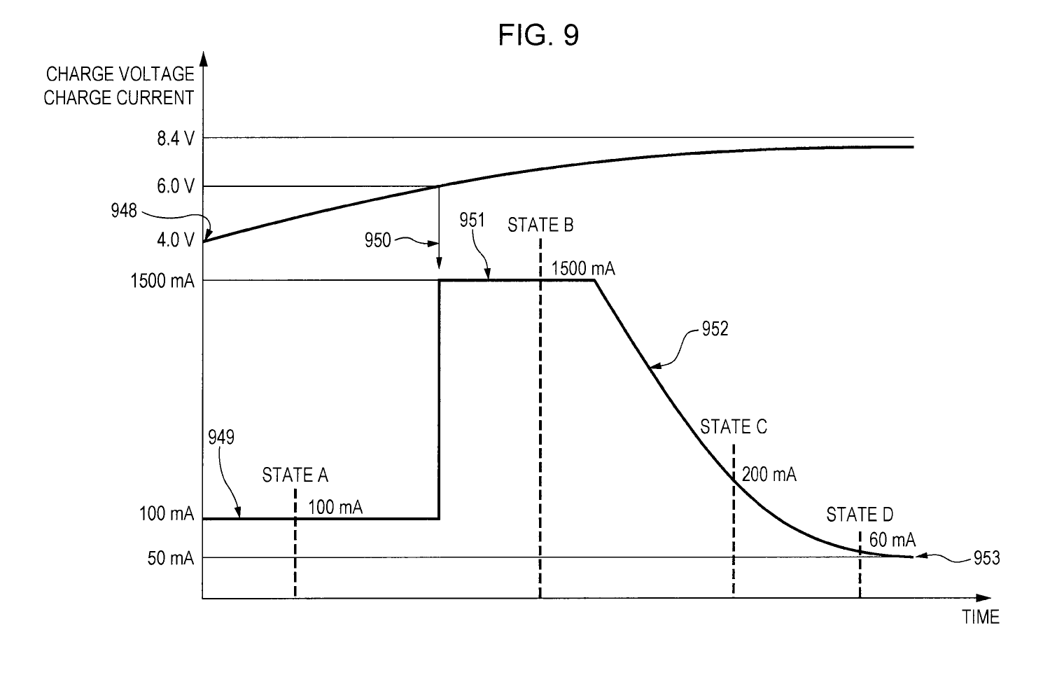

Charge characteristics of a lithium-ion assembled battery in which two battery cells are connected in series are as shown in FIG. 9.

If discharge of a battery proceeds and the battery voltage drops to about 4 V, the internal impedance increases, a voltage effect on the discharge current increases, and thereby, it is usually difficult in practice to use the battery. Further, if discharging proceeds and the battery voltage drops lower than 4 V, precipitation of lithium metal is usually found in the electrode of a cell. Due to the precipitation of lithium metal, movement of ions within the cell is restricted causing deterioration of the cell, and thus, if a protective circuit (not shown) is provided inside the battery and then the battery voltage drops to about 4 V, the battery will not be discharged over the level. Therefore, when a lithium-ion battery that has completed discharging is charged, charging is performed from the charge voltage of 4 V as indicated by reference numeral 948.

Further, the battery voltage of the lithium-ion assembled battery in which two battery cells are connected in series is 8.4 V when fully charged, and it is necessary to perform charging by finally applying 8.4 V during the charging. However, if the charge voltage of 8.4 V is applied from the beginning of charging, the potential difference between the charge voltage and the battery voltage becomes great, causing deterioration of the cells due to inflow of a high current to the battery. For this reason, at the first place of charging, it is necessary to perform charging with a low current of about 100 mA as indicated by reference numeral 949.

Then, the charging proceeds and then the battery voltage becomes about 6 V as indicated by reference numeral 950, the potential difference between the charge voltage and the battery voltage becomes small, and a high current does not flow into the battery, and thus, the charging operation is switched from constant-current charge with 100 mA to constant-voltage charge with 8.4 V.

In the case of USB charging, the power feeding capability of the USB charger 114 is 1500 mA. Thus, after the operation is switched to the constant-voltage charge with 8.4 V, charging with 1500 mA continues for a while as indicated by reference numeral 951.

Further, if the charging proceeds and the potential difference between the charge voltage and the battery voltage becomes smaller, the charge current gradually decreases as indicated by reference numeral 952. Then, the charge current gradually decreases and then drops to about 50 mA, the capacity of the battery barely increases even if the charging further continues, and thus, the charging is completed as indicated by reference numeral 953.

Herein, a charging operation when a battery to be charged in the present embodiment is in each state of A to D in the above-described charge process will be described.

State A: At the time of constant current charge with 100 mA (reference numeral 949)

State B: At the time of charge with 1500 mA that is the maximum current of USB charge (reference numeral 951)

State C: At the time when the charge current gradually decreases (reference numeral 952), and then becomes 200 mA

State D: At the time when the charge current becomes 60 mA and then approaches to charge completion (reference numeral 953)

In the present embodiment, charging is controlled so that batteries are charged in the order of from the highest charge current value. Thus, if charge control is performed in accordance with the procedure illustrated in FIG. 7A, charging is performed based on the priority of state B→state C→state A→state D in the order of the charge currents.

The timing chart of FIG. 7B exemplifies the performance of charge control for the battery “1” and the battery “2” that are in different states according to the procedure illustrated in FIG. 7A.

The battery “1” is in the state B, and 1500 mA that is the maximum current of USB charge is acquired from basic charge control (1) as the charge current “1” thereof. On the other hand, the battery “2” in the state C, and the charge current thereof gradually decreases. 400 mA is acquired from basic charge control (2) as the charge current “2” thereof. Thus, in the main charge, the battery “1” with the higher charge current is charged first.

When charging of the battery “1” proceeds, the potential difference between the charge voltage and the battery voltage becomes small, and the charge current gradually decreases. Then, the charge current decreases and then drops to a predetermined threshold value of about 50 mA. The charge current “2” of the battery “2” increases in the middle of charging the battery “1”, but in the procedure illustrated in FIG. 7A, once charging of the battery “1” is selected, the charging continues until the battery “1” is fully charged. After that, the charging of the battery “1” is completed, and charging of the battery “2” is started. When charging of the battery “2” proceeds, the potential difference between the charge voltage and the battery voltage becomes small, and the charge current gradually decreases. Then, when the charge current decreases and then drops to the predetermined threshold value of about 50 mA, charging of the battery “2” is also completed. Thus, as illustrated in the drawing, charging of the batteries “1” and “2” is performed in the order of arrows A→B→C→D→E.

If charging is performed in the order of from batteries having the highest charge current value, the time taken to fully charge all of the batteries is not affected by the charge order, but when charging is to be stopped before all of the batteries are fully charged, charging is performed first for a battery having a higher charge current, and the charge current integrated value becomes great, which is efficient.

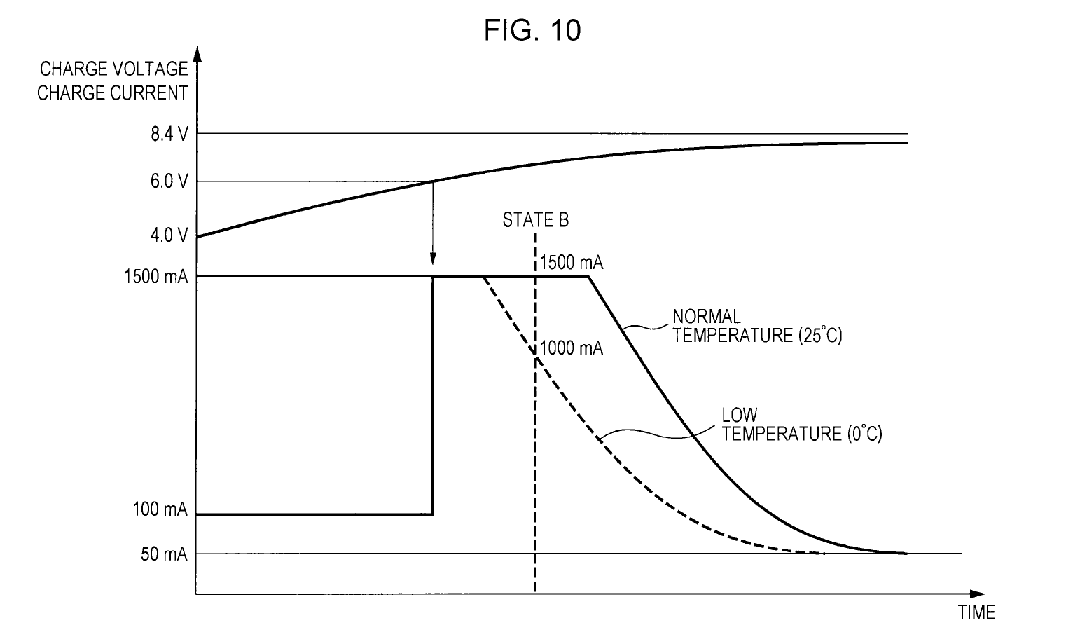

FIG. 10 illustrates a temperature characteristic of the lithium-ion battery according to the first embodiment of the present disclosure. In the drawing, in the same manner as in FIG. 9, the horizontal axis indicates time and the vertical axis indicates a charge voltage (battery voltage) and a charge current, and a charge characteristic of the lithium-ion assembled battery in which two battery cells are connected in series at each temperature is shown.

If temperature of the cells becomes low, the internal impedance of the lithium-ion battery increases generally. For this reason, the charge current in the state B, of example, is lowered to 1500 mA at the normal temperature (25° C.) and 1000 mA at a lower temperature (0° C.).

Thus, if charging is to be performed in the order of from batteries having higher charge currents as described above, charging is performed from a battery under the normal temperature (25° C.) to a battery under a lower temperature (0° C.) in this order. The time taken to fully charge all of the batteries is not affected by the charge order, but when charging is to be stopped before all of the batteries are fully charged, charging is performed first for a battery having a higher charge current, and the charge current integrated value becomes great, which is efficient.

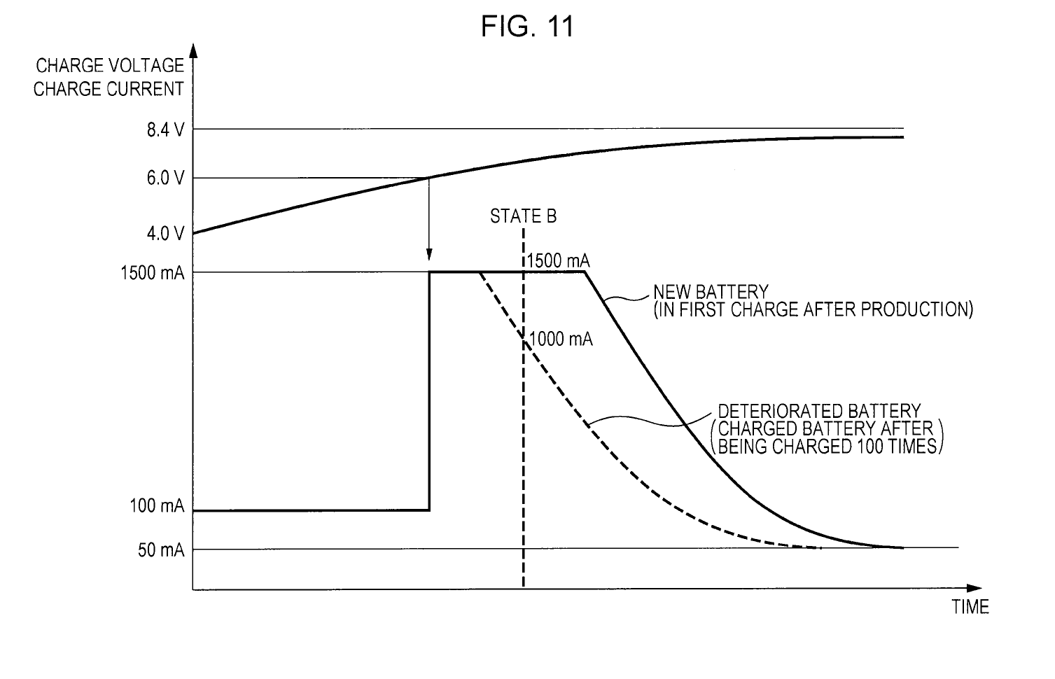

FIG. 11 illustrates the effect of deterioration of the battery exerted on a charge characteristic of the lithium-ion battery according to the first embodiment of the present disclosure. In the drawing, in the same manner as in FIG. 9, the horizontal axis indicates time and the vertical axis indicates a charge voltage (battery voltage) and a charge current.

If the cells deteriorate due to repetitive charge and discharge, the internal impedance of the lithium-ion battery increases generally. For this reason, the charge current in the state B, for example, is lowered to 1500 mA in the case of a new battery (at the time of first charge after the production), but to 1000 mA in the case of a deteriorated battery (at the time of charge after being discharged 100 times).

Thus, if charging is to be performed in the order of batteries having higher charge currents as described above, charging is performed from a new battery (at the time of first charge after the production) to a deteriorated battery. The time taken to fully charge all of the batteries is not affected by the charge order, but when charging is to be stopped before all of the batteries are fully charged, charging is performed first for a battery having a higher charge current, and the charge current integrated value becomes great, which is efficient.

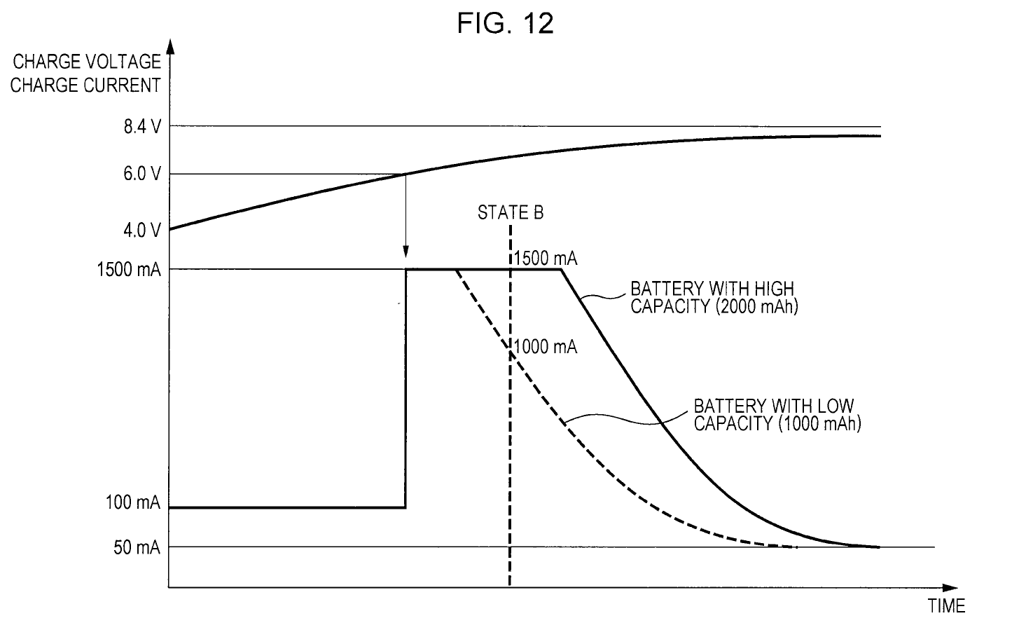

Further, FIG. 12 illustrates the effect of a battery capacity exerted on the charge characteristic of the lithium-ion battery according to the first embodiment of the present disclosure. In the drawing, in the same manner as in FIG. 9, the horizontal axis indicates time and the vertical axis indicates a charge voltage (battery voltage) and a charge current.

Generally, the internal impedance of the lithium-ion battery decreases as the battery has a greater capacity. For this reason, the charge current in the state B, for example, is lowered to 1500 mA in the case of a battery with a large capacity (2000 mAh), but to 1000 mA in the case of a battery with a small capacity (1000 mAh).

Thus, if charging is to be performed in the order of batteries having higher charge currents as described above, charging is performed from a battery with a large capacity (2000 mAh) to a battery with a small capacity (1000 mAh). The time taken to fully charge all of the batteries is not affected by the charge order, but when charging is to be stopped before all of the batteries are fully charged, charging is performed first for a battery having a higher charge current, and the charge current integrated value becomes great, which is efficient.

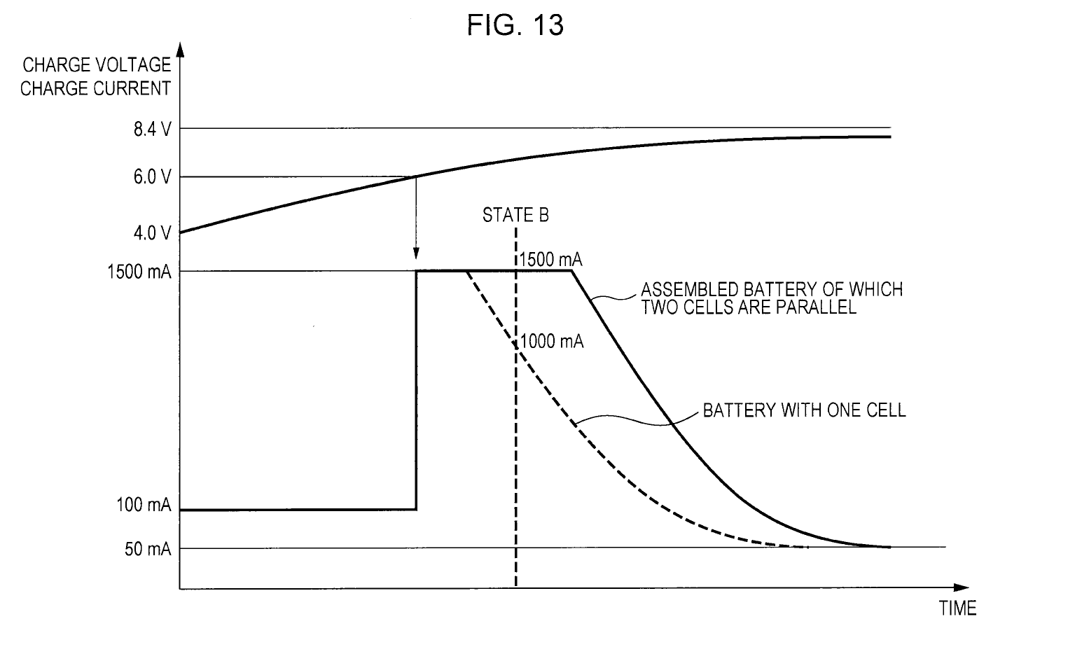

Further, FIG. 13 illustrates the effect of the number of parallel cells exerted on the charge characteristic of the lithium-ion battery according to the first embodiment of the present disclosure. In the drawing, in the same manner as in FIG. 9, the horizontal axis indicates time and the vertical axis indicates a charge voltage (battery voltage) and a charge current.

In some cases, the lithium-ion battery is used as an assembled battery formed by connecting cells in parallel and put in one package. If cells are connected in parallel, the impedance thereof is lower than in a battery with one cell. For this reason, the charge current in the state B, for example, is lowered to 1500 mA in the case of an assembled battery in which two cells are connected in parallel, and to 1000 mA in the case of a battery with one cell.

Thus, if charging is to be performed in the order of batteries having higher charge currents as described above, charging is performed from an assembled battery with two parallel cells to a battery with one cell. The time taken to fully charge all of the batteries is not affected by the charge order, but when charging is to be stopped before all of the batteries are fully charged, charging is performed first for a battery having a higher charge current, and the charge current integrated value becomes great, which is efficient.

Charging of such a lithium-ion battery should be controlled so as not to exceed a temperature stipulated in safety regulations such as the electrical appliances and material safety act. For this reason, the temperature is measured in the battery “1” by the microcomputer 155 causing the thermistor 163 to measure the temperature and in the battery “2” by the microcomputer 170 causing the thermistor 178 to measure the temperature. Thus, the control unit 128 of the main body of the digital camera 101 acquires the temperature of a battery currently being charged among the battery “1” or the battery “2” based on the communication command “0x04” by the C terminal. Herein, when the temperature is equal to or higher than the stipulated temperature threshold value, the control unit 128 controls the switch 127 using the signal line 129 to set the state of “connection on the constant-current circuit side and disconnection on the directly connected line side”, and then, the charge current is restricted to 100 mA using the constant-current circuit 130 in order to prevent a temperature rise in the battery.

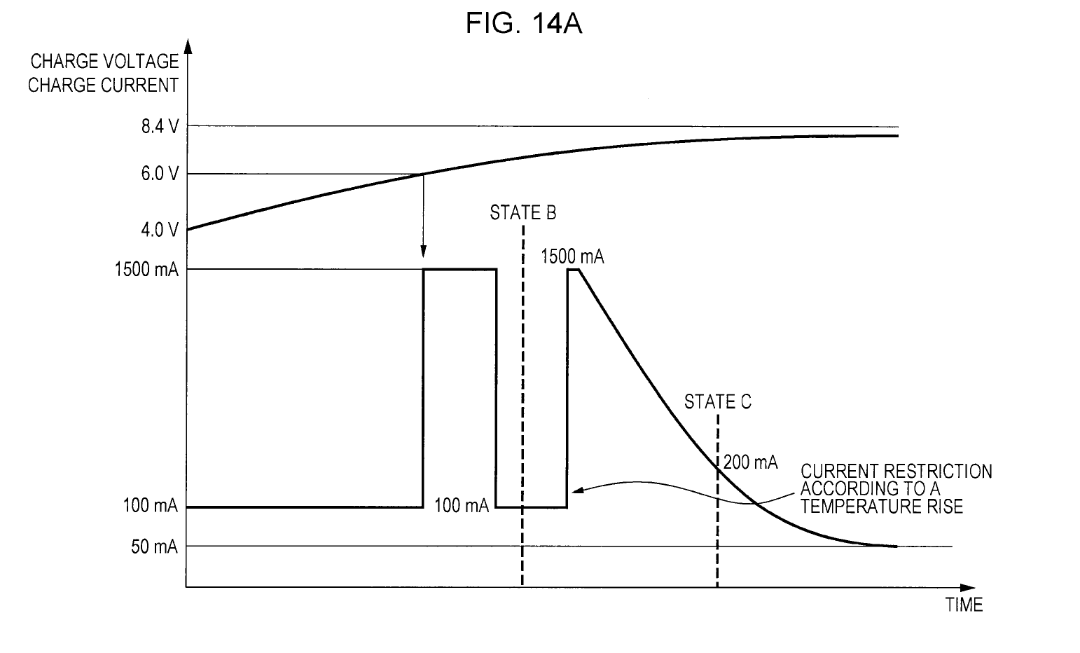

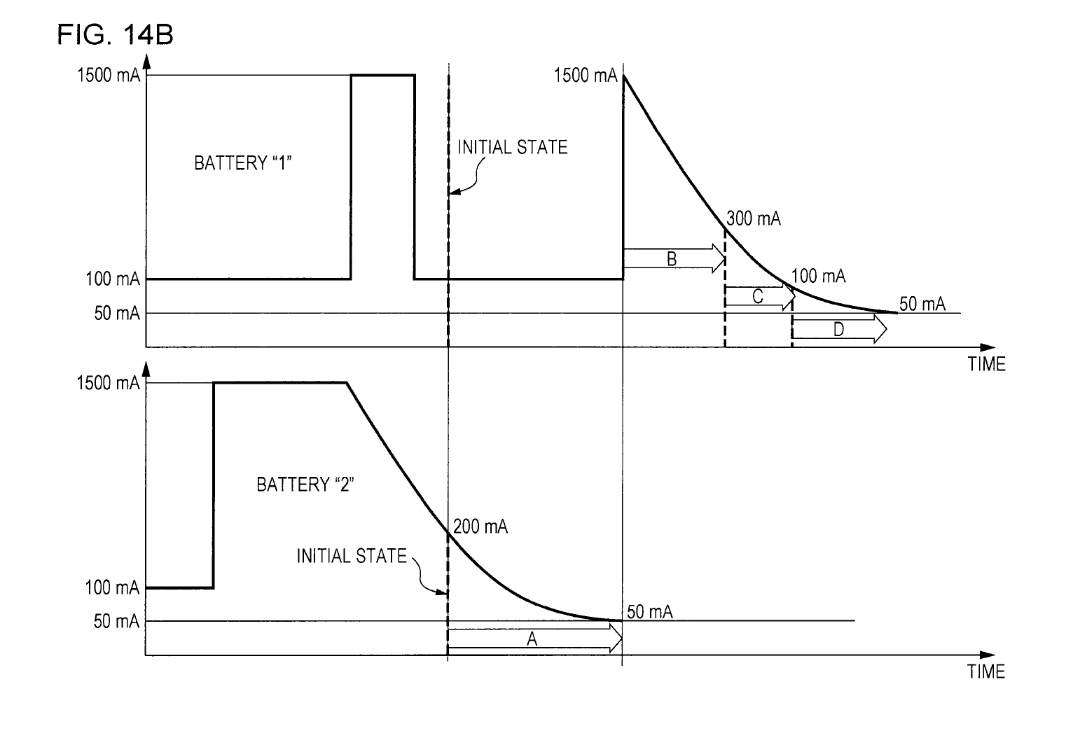

When the temperature is lower than the threshold value and the process of preventing a temperature rise is not performed, the charge current is 1500 mA in the state B and 200 mA in the state C, and thus, charging is performed from a battery in the state B and a battery in the state C in order. In regard to this operation, when the temperature of the battery in the state B becomes higher than the threshold value, and then the process of preventing a temperature rise is operated, causing the charge current to be restricted to 100 mA, the charge current of the battery in the state C becomes higher (refer to FIG. 14A). Thus, charging is performed from the battery in the state C to the battery in the state B in order.

Thus, if charging is to be performed in the order of batteries having higher charge currents as described above, charging is performed from a battery for which the process of preventing a temperature rise is not performed to a battery for which the process of preventing a temperature rise is performed in order. The time taken to fully charge all of the batteries is not affected by the charge order, but when charging is to be stopped before all of the batteries are fully charged, charging is performed first for a battery having a higher charge current, and the charge current integrated value becomes great, which is efficient.

The timing chart of FIG. 14B exemplifies the performance of charge control for the battery “1” for which a temperature restriction is performed and the battery “2” for which a temperature restriction is not performed according to the procedure illustrated in FIG. 14A.

The battery “1” is in the state B in which the process of preventing a temperature rise is performed and the charge current is restricted to 100 mA, and 100 mA that is the maximum current of USB charge is acquired from the basic charge control (1) as the charge current “1” thereof. On the other hand, the battery “2” is in the state C, and the charge current thereof gradually decreases. 200 mA is acquired from the basic charge control (2) as the charge current “2” thereof. Therefore, in the main charge, the battery “2” with a higher charge current is charged first.

When charging of the battery “2” proceeds, the potential difference between the charge voltage and the battery voltage becomes small, and then the charge current gradually decreases. Then, when the charge current decreases and then is lowered to a predetermined threshold value of about 50 mA, charging of the battery “2” is completed.

At this point, it is assumed that the temperature of the battery “1” decreases to a point equal to or lower than the threshold value, and the process of preventing a temperature rise is finished. 1500 mA that is the maximum charge current of USB charge is acquired from the basic charge control (1) as the charge current “1” thereof, and charging of the battery “1” is started. When charging of the battery “1” proceeds, the potential difference between the charge voltage and the battery voltage becomes small, and then the charge current gradually decreases. Then, when the charge current decreases and then is lowered to the predetermined threshold value of about 50 mA, charging of the battery “1” is completed. Therefore, as illustrated in the drawing, charging of the batteries “1” and “2” is performed in the order of arrows A→B→C→D.

### Second Embodiment

Hitherto, charge control of a lithium-ion battery has been described. However, the technology disclosed in the present disclosure can be applied in the same way as above to batteries to be used including not only lithium-ion batteries but also other general secondary batteries such as nickel-metal hydride batteries, nickel-cadmium batteries, and lead batteries. Secondary batteries generally have the same characteristics as lithium-ion batteries such as “the necessity of current restriction in a low voltage” (Premise 1), “an increase in the internal impedance due to a low temperature” (Premise 2), “an increase in the internal impedance due to deterioration” (Premise 3), “a decrease in the internal impedance in the case of an assembled battery” (Premise 4), and “the necessity of current restriction to satisfy safety regulations” (Premise 5). Therefore, if charging is performed in the order of batteries having higher charge currents, in the same manner as above, the time taken to fully charge all of the batteries is not affected by the charge order, but when charging is to be stopped before all of the batteries are fully charged, the charge current integrated value, that is, the total charge amount of all batteries becomes great, which is efficient.

### Third Embodiment

Hitherto, charge control of when two batteries are charged at the same time has been described, but the technology disclosed in the present disclosure can be applied in the same manner to even a case in which three or more batteries are used. Even if there are three or more batteries to be used, it may be possible to sequentially perform test charges for respective batteries to obtain the charge currents thereof, and then to start charging in the order of batteries having higher current values. The time taken to fully charge all of the batteries is not affected by the charge order, but when charging is to be stopped before all of the batteries are fully charged, the charge current integrated value, that is the total charged amount of all batteries becomes great, which is efficient.

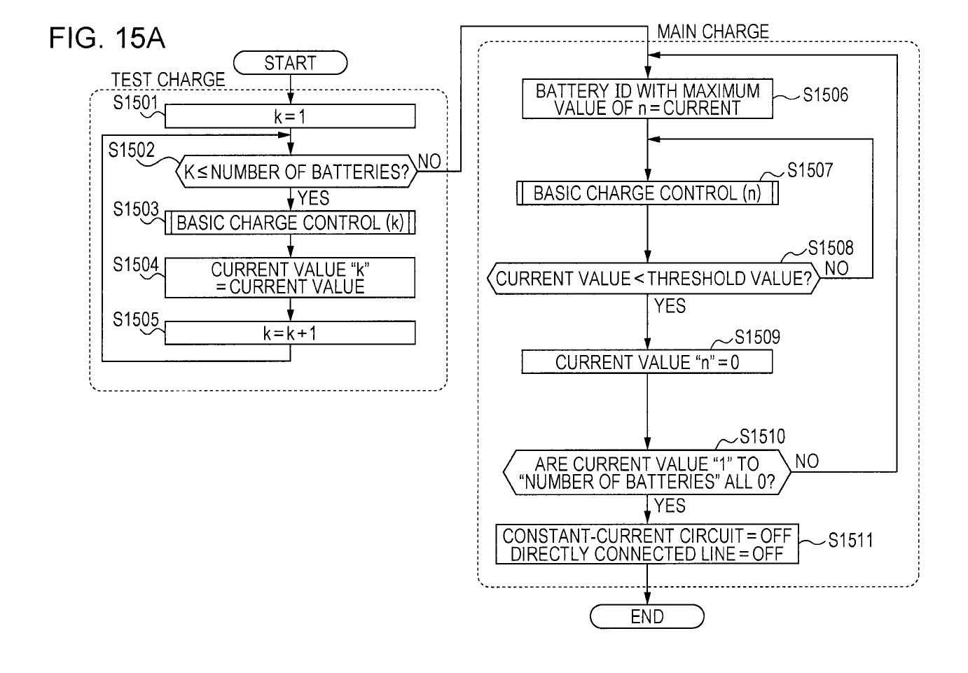

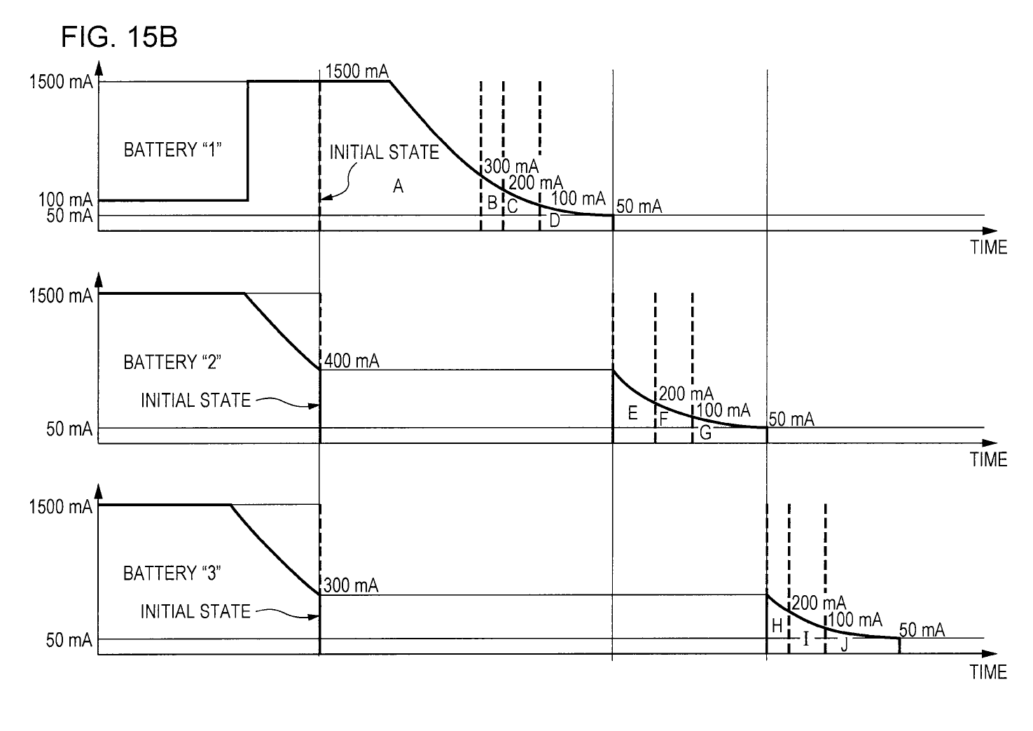

FIG. 15A illustrates a procedure of charge control by the control unit 128 of the main body of the digital camera 101 for an arbitrary number of batteries in the form of a flowchart according to a third embodiment of the present disclosure. As illustrated in the drawing, charge control is performed for the test charge, and the main charge in order.

In the test charge, first, a process that an initial value 1 is substituted for a variable k (Step S1501) in order to count the number of batteries subject to test charge, basic charge control is performed for a battery “k” (Step S1503), a charge current value “k” of the battery “k” is acquired (Step S1504), and k is augmented one by one (Step S1505) and is repeated until k reaches the number of batteries (Yes in Step S1502). The procedure of the basic charge control performed in Step S1503 is the same as shown in FIG. 8.

Then, when k reaches the number of batteries (No in Step S1502), the test charge is finished, and subsequently, the main charge is started.

In the main charge, first when a battery ID of which the charge current value acquired in the test charge is at the maximum is acquired, the battery ID is substituted for the variable n indicating a battery ID for performing the main charge (Step S1506). At this time, if there are two or more batteries having the same current value, the lowest battery ID is selected for the sake of convenience.

Next, basic charge control is performed for a battery “n” (Step S1507). The basic charge control of the battery “n” continues until charging of the battery “n” proceeds, the potential difference between the power source voltage for charging and the battery voltage becomes small, and thereby the charge current value is lower than a predetermined threshold value stored in the control unit 128 (No in Step S1508). Then, if the charge current value is lower than the predetermined threshold value stored in the control unit 128 (Yes in Step S1508), 0 is substituted for the current value “n” of the battery “n” (Step S1509), indicating that charging is completed.

The charge operation of Steps S1506 to S1509 is repeated until the current value of all batteries becomes 0, in other words, until charging of all batteries is completed (No in Step S1510).

Then, when charging of all batteries is completed (Yes in Step S1510), the state of “disconnection on the constant-current circuit side and disconnection on the directly connection line side” is set (Step S1511), and thereby charging control is finished.

The timing chart of FIG. 15B illustrates the performance of charge control for three batteries of the battery “1”, battery “2”, and battery “3” according to the procedure illustrated in FIG. 15A.

Charge currents in the initial state of the batteries “1”, “2”, and “3” are acquired from test charge. As a result, 1500 mA that is the maximum charge of USB charge is acquired as the charge current “1” of the battery “1”. In addition, the charge currents of the batteries “2” and “3” gradually decrease, and charge currents of 400 mA and 300 mA are respectively acquired in the initial state. Thus, in the main charge, the battery “1” having the higher charge current is charged first.

When charging of the battery “1” proceeds, the potential difference of the charge voltage and the battery voltage becomes small, and the charge current gradually decreases. Then, when the charge current decreases and then is lowered to the predetermined threshold value of about 50 mA, the charging of the battery “1” is completed.

Subsequently, charging of the battery “2” having the second highest charge current value in the initial state is started. When charging of the battery “2” proceeds, the potential difference of the charge voltage and the battery voltage becomes small, and the charge current gradually decreases. Then, when the charge current decreases and then is lowered to the predetermined threshold value of about 50 mA, the charging of the battery “2” is completed.

Finally, charging of the battery “3” having the lowest charge current in the initial state is started. When charging of the battery “3” proceeds, the potential difference of the charge voltage and the battery voltage becomes small, and the charge current gradually decreases. Then, when the charge current decreases and then is lowered to the predetermined threshold value of about 50 mA, the charging of the battery “3” is completed.

Thereby, charging of the batteries “1”, “2”, and “3” is executed in the order of A→B→C→D→E→F→G→H→I→J as illustrated in the drawing.

If charging is performed from batteries having higher charge current in order, the time taken to fully charge all of the batteries is not affected by the charge order, but when charging is to be stopped before all of the batteries are fully charged, charging is performed first for a battery having a higher charge current, and the charge current integrated value becomes great, which is efficient.

### Fourth Embodiment

With reference to FIGS. 1 to 4, embodiments have been described in which charge control is performed for the batteries “1” and “2” inserted in the vertical position grip 103 on the main body of the digital camera 101, but the gist of the technology disclosed in the present disclosure is not limited thereto, and the same effects can be obtained even if the charge control is performed by directly inserting the two batteries into the main body of the digital camera 101 without using the vertical position grip 103.

### Fifth Embodiment

Hitherto, embodiments has been described in which the main body of the digital camera 101 performs charge control for a plurality of batteries, but even when a general electronic device other than such a digital camera simultaneously charges two or more batteries, the technology disclosed in the present disclosure can be applied thereto in the same manner. For example, to various electronic devices using a plurality of secondary batteries as the power source, such as dedicated chargers, personal computers, mobile telephones, portable music reproducing devices, vehicles, railway vehicles, vessels, aircrafts, satellites, robots, houses, lighting devices, medical devices, measuring instruments, machine tools, televisions, radios, transceivers, emergency power sources, and the like, the technology disclosed in the present disclosure can be applied in the same manner.

### Sixth Embodiment

In the procedure of charge control illustrated in FIG. 7A, it is configured that, when the charge current value of each battery is acquired in the test charge, after charging is completed for a battery having a higher charge current, charging is started for a battery having a lower charge current value (having the second highest charge current value) in the main charge. In other words, in the main charge, once charging is started for a battery, charging will not be switched to another battery until the previous charging is completed.

As a modification example of charge control, it may be configured that, after the main charge is started, when the charge current value of the battery being charged is lower than the current value acquired from the battery not being charged by a fixed value or higher, a battery to be charged is switched. Herein, the reason for setting the hysteresis of “a fixed value” is to stabilize charge control so that a battery to be charged will not be frequently switched.

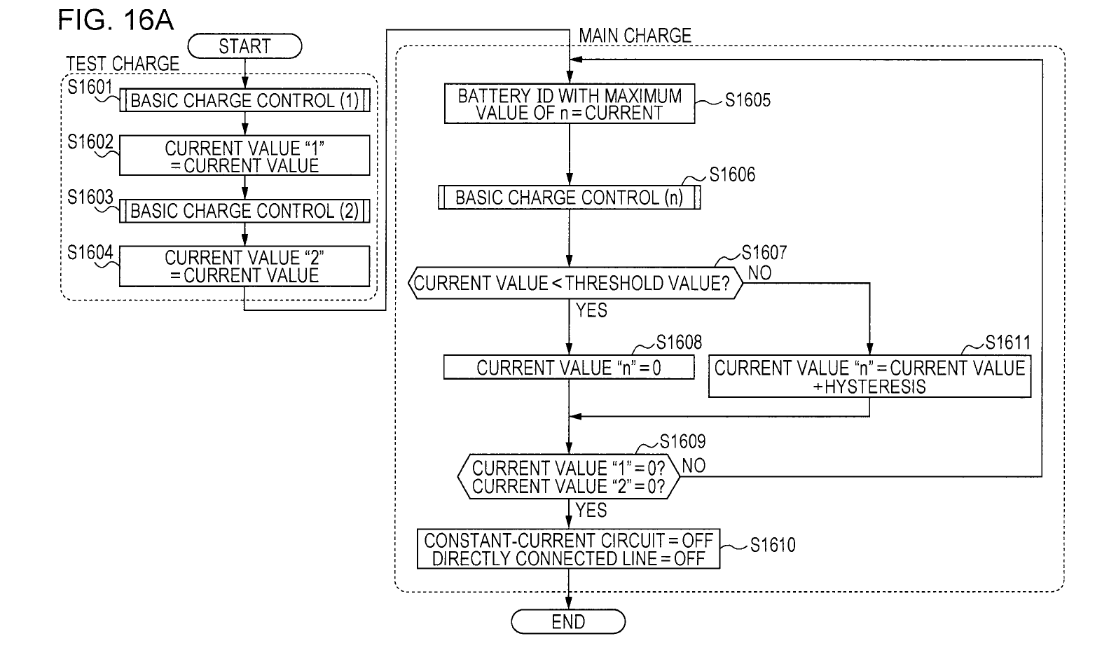

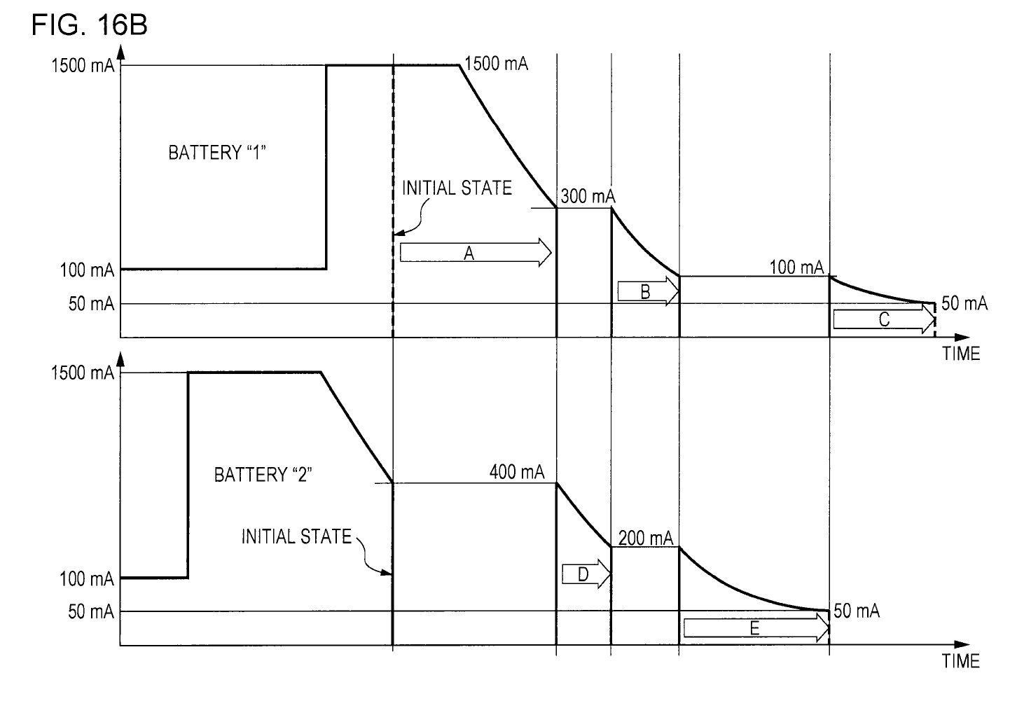

FIG. 16A shows a procedure of charge control by the control unit 128 of the main body of the digital camera 101 in the form of a flowchart according to a sixth embodiment of the present disclosure. As shown in the drawing, charge control is performed from the test charge to the main charge in order, but in the main charge, when the charge current value of the battery being charged is lower than the current value acquired from the battery not being charged by a fixed value or higher, a battery to be charged is switched.

When charging is started, basic charge control for the battery “1” 109 is first performed (Step S1601), a charge current value “1” of the battery “1” 109 is acquired (Step S1602), subsequently, basic charge control is performed for the battery “2” 110 (Step S1603), and then a charge current value “2” of the battery “2” 110 is acquired (Step S1604). The procedure of the basic charge control is the same as that illustrated in FIG. 8.

Thereby, the test charge ends, and then the main charge starts.

In the main charge, first, when a battery ID of which the present charge current value is at the maximum is acquired, the battery ID is substituted for the variable n indicating a battery ID for performing the main charge (Step S1605). At this time, if there are two or more batteries having the same current value, the lowest battery ID is selected for the sake of convenience.

Next, basic charge control is performed for a battery “n” (Step S1606). The charging of the battery “n” proceeds, the potential difference between the power source voltage for charging and the battery voltage becomes small, and thereby the charge current value becomes lower. Then, if the charge current value of the battery “n” is lower than the predetermined threshold value stored in the control unit 128 (Yes in Step S1607), 0 is substituted for the current value “n” of the battery “n” (Step S1608), indicating that charging is completed. On the other hand, the charge current value of the battery “n” is not lower than the predetermined threshold value stored in the control unit 128 (No in Step S1607), a hysteresis is added to the current value “n” of the battery “n” (Step S1611). The hysteresis is designed to be arbitrarily determined in accordance with a system.

The charge control of Steps S1605 to S1608 is repeated until the current value of all batteries becomes 0, in other words, until charging of all batteries is completed (No in Step S1609).

Then, when charging of all batteries is completed (Yes in Step S1609), the state is set to be “disconnection on the constant-current circuit side and disconnection on the directly connected line side” (Step S1610), and thereby the charge control ends.

The timing chart of FIG. 16B exemplifies the performance of charge control for the battery “1” and the battery “2” which are in different states according to the procedure illustrated in FIG. 16A. Herein, it is assumed that 100 mA is set as a hysteresis of the charge current.

For the battery “1”, 1500 mA that is the maximum current of USB charge is acquired in the initial state. On the other hand, for the battery “2”, the charge current gradually decreases in the initial state, and 400 mA is acquire as the charge current “2” thereof. Thus, in the main charge, the battery “1” having the higher charge current is charged first.

When charging of the battery “1” proceeds, the potential difference between the charge voltage and the battery voltage becomes small, and the charge current, that is, the current value “1” gradually decreases. While the charge current is not lowered to the predetermined threshold value of about 50 mA, a hysteresis of 100 mA is added to the present charge current of the battery “1”. Then when the current value “1” to which the hysteresis of 100 mA is added is greater than the current value “2” of the battery “2”, charging of the battery “1” continues.

When the charging of the battery “1” further proceeds, the current value “1” to which the hysteresis of 100 mA is added is lower than 400 mA that is the current value “2” of the battery “2”. Then, the charging of the battery “1” is stopped, and the operation is switched to charging of the battery “2”.

When charging of the battery “2” proceeds, the charge current, that is, the current value “2” gradually decreases. While the charge current is not lowered to the predetermined threshold value of about 50 mA, a hysteresis of 100 mA is added to the present charge current of the battery “2”. Then, if the current value “2” to which the hysteresis of 100 mA is added is greater than the current value “1” of 300 mA of the battery “1”, the charging of the battery “2” continues.

When the charging of the battery “2” further proceeds, the current value “2” to which the hysteresis of 100 mA is added is lower than 300 mA that is the current value “1” of the battery “1”. Then, the charging of the battery “2” is stopped, and the operation is switched to charging of the battery “1” again.

When charging of the battery “1” proceeds, the charge current, that is, the current value “1” gradually decreases. While the charge current is not lowered to the predetermined threshold value of about 50 mA, a hysteresis of 100 mA is added to the present charge current of the battery “1”. Then, if the current value “1” to which the hysteresis of 100 mA is added is greater than the current value “2” of 400 mA of the battery “2”, the charging of the battery “1” continues, but if the current value is lower than 400 mA, the charging of the battery “1” is stopped, and the operation is switched to charging of the battery “2” again.

When the charging of the battery “2” further proceeds, and the charge current is lowered to the predetermined threshold value of about 50 mA, the charging of the battery “2” is completed, and the operation is switched to charging of the battery “1” again. In addition, when the charging of the battery “1” further proceeds and the charge current is lowered to the predetermined threshold value of about 50 mA, the charging of the battery “1” is completed.

Therefore, as illustrated in the drawing, charging of the batteries “1” and “2” is executed in the order of arrows A→D→B→E→C. If charging of the batteries “1” and “2” is alternately executed, the time taken to fully charge all batteries does not change, but when charging is stopped before all batteries are fully charged, charging of each battery is fulfilled substantially equally, and therefore, the operation is more efficient.

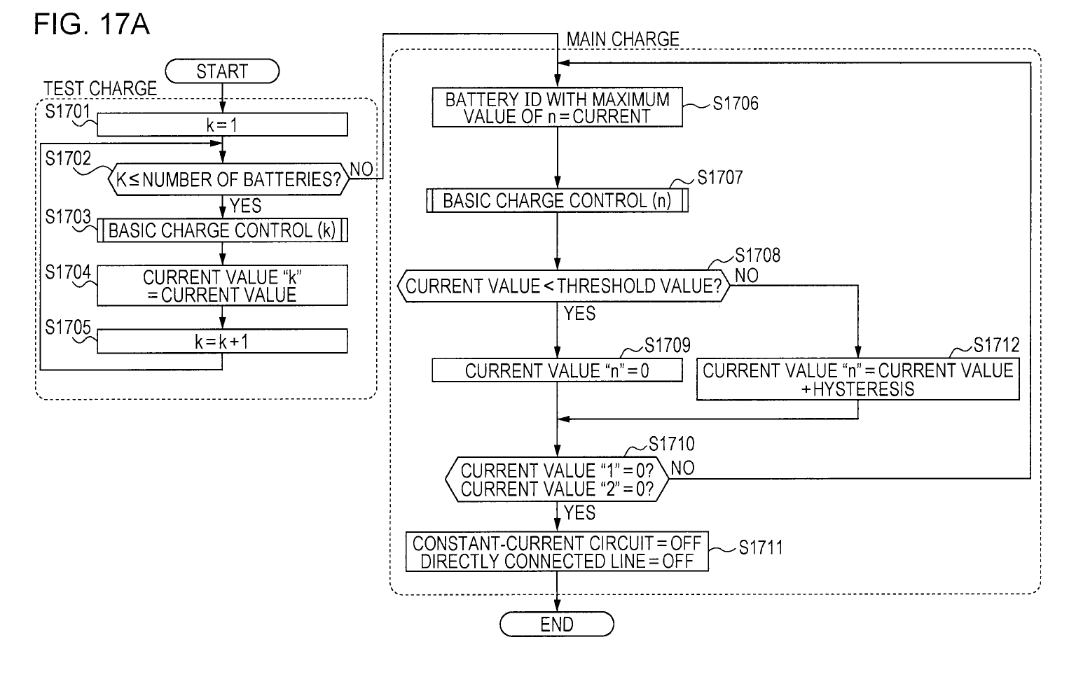

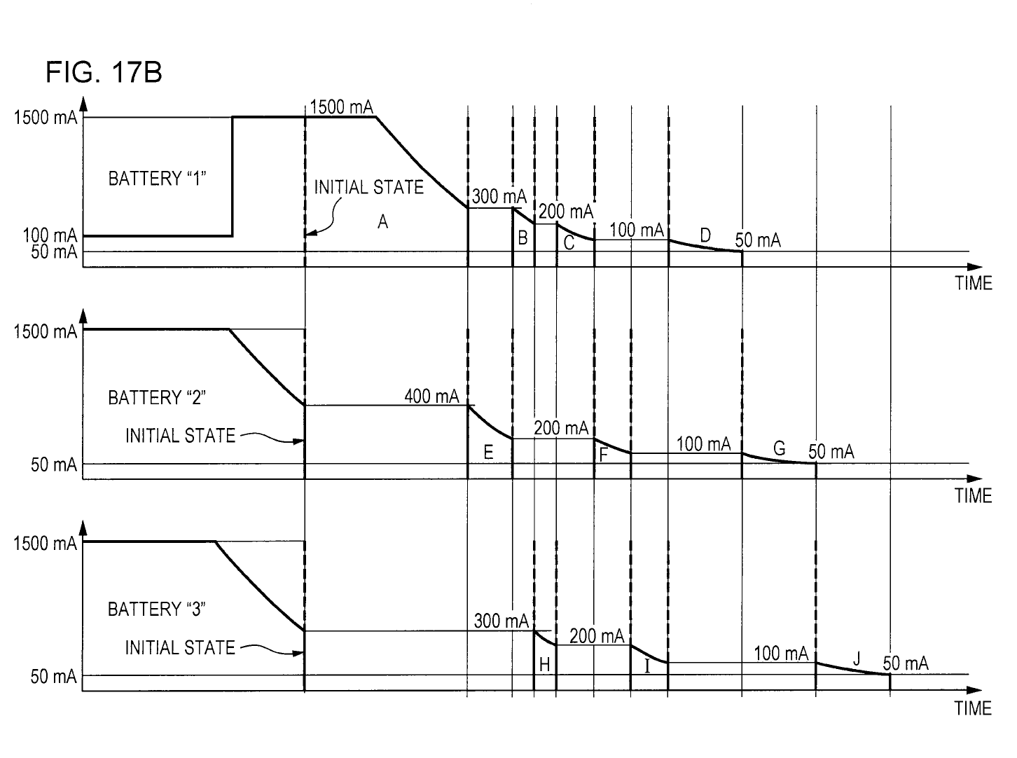

FIG. 17A shows a procedure of charge control by the control unit 128 of the main body of the digital camera 101 for an arbitrary number of batteries in the form of a flowchart according to the sixth embodiment of the present disclosure. As illustrated, the charge control is performed from test charge to main charge in order, but in the main charge, if the charge current value of a battery being charged is lower than the current value acquired from a battery not being charged by a fixed value, a battery to be charged is switched.

In the test charge, first, a process that an initial value 1 is substituted for a variable k for counting the number of batteries subject to test charge (Step S1701), basic charge control is performed for a battery “k” (Step S1703), a charge current value “k” of the battery “k” is acquired (Step S1704), and k is augmented one by one (Step S1705) and is repeated until k reaches the number of batteries (Yes in Step S1702). The procedure of the basic charge control performed in Step S1703 is the same as shown in FIG. 8.

Then, when k reaches the number of batteries (No in Step S1702), the test charge is finished, and subsequently, the main charge is started.

In the main charge, first, when a battery ID of which the present charge current value acquired in the test charge is at the maximum is acquired, the battery ID is substituted for the variable n indicating a battery ID for performing the main charge (Step S1706). At this time, if there are two or more batteries having the same current value, the lowest battery ID is selected for the sake of convenience.

Next, basic charge control is performed for a battery “n” (Step S1707). The charging of the battery “n” proceeds, the potential difference between the power source voltage for charging and the battery voltage becomes small, and thereby the charge current value becomes lower. Then, if the charge current value of the battery “n” is lower than the predetermined threshold value stored in the control unit 128 (Yes in Step S1708), 0 is substituted for the current value “n” of the battery “n” (Step S1709), indicating that charging is completed. On the other hand, the charge current value of the battery “n” is not lower than the predetermined threshold value stored in the control unit 128, a hysteresis is added to the current value “n” of the battery “n” (Step S1712). The hysteresis is designed to be arbitrarily determined in accordance with a system.

The charge control of Steps S1706 to S1709 is repeated until the current value of all batteries becomes 0, in other words, until charging of all batteries is completed (No in Step S1710).

Then, when charging of all batteries is completed (Yes in Step S1710), the state is set to be “disconnection on the constant-current circuit side and disconnection on the directly connected line side” (Step S1711), and thereby the charge control ends.

The timing chart of FIG. 17B exemplifies the performance of charge control for three batteries “1”, “2”, and “3” according to the procedure illustrated in FIG. 17A. Herein, it is assumed that 100 mA is set as a hysteresis of the charge current.

From the test charge, the charge currents of the batteries “1”, “2”, and “3” in an initial state are acquired. As a result, as the charge current “1” of the battery “1”, 1500 mA that is the maximum current of USB charge is acquired. In addition, the charge currents of the batteries “2” and “3” are in the state of gradually decreasing, and respective charge currents of 400 mA and 300 mA are acquired in the initial state. Thus, in the main charge, the battery “1” having the highest charge current value is charged first.

When charging of the battery “1” proceeds, the potential difference between the charge voltage and the battery voltage becomes small, and the charge current, that is, the current value “1” gradually decreases. While the charge current is not lowered to the predetermined threshold value of about 50 mA, a hysteresis of 100 mA is added to the present charge current of the battery “1”. Then when the current value “1” to which the hysteresis of 100 mA is added is greater than the current values “2” and “3” of the batteries “2” and “3”, charging of the battery “1” continues.

When the charging of the battery “1” further proceeds, the current value “1” to which the hysteresis of 100 mA is added is lower than 400 mA that is the current value “2” of the battery “2”. Then, the charging of the battery “1” is stopped, and the operation is switched to charging of the battery “2”.

When charging of the battery “2” proceeds, the charge current, that is, the current value “2” gradually decreases. While the charge current is not lowered to the predetermined threshold value of about 50 mA, a hysteresis of 100 mA is added to the present charge current of the battery “2”. Then, if the current value “2” to which the hysteresis of 100 mA is added is greater than the current values “1” and “3” of the batteries “1” and “3”, the charging of the battery “2” continues.

When the charging of the battery “2” further proceeds, the current value “2” to which the hysteresis of 100 mA is added is lower than the current values “1” and “3” of the batteries “1” and “3”. Then, the charging of the battery “2” is stopped, and the operation is switched to charging of the battery “1” again. The current values “1” and “3” are the same, but in this case, charging is switched to a battery with a lower battery ID.

When charging of the battery “1” proceeds, the charge current, that is, the current value “1” gradually decreases. While the charge current is not lowered to the predetermined threshold value of about 50 mA, a hysteresis of 100 mA is added to the present charge current of the battery “1”. Then, if the current value “1” to which the hysteresis of 100 mA is added is greater than the current values “2” and “3” of the batteries “2” and “3”, the charging of the battery “1” continues, but if the current value is lower than the current values “2” and “3” of the batteries “2” and “3”, the charging of the battery “1” is stopped, and the operation is switched to charging of the battery “2” again. The current values “2” and “3” are the same, but in this case, charging is switched to a battery with a lower battery ID.

When the charging of the battery “2” further proceeds, and the charge current is lowered to the predetermined threshold value of about 50 mA, the charging of the battery “2” is completed, and the operation is switched to charging of the battery “1” again. The current values “1” and “3” are the same, but in this case, charging is switched to a battery with a lower battery ID.

When the charging of the battery “1” further proceeds, and the charge current is lowered to the predetermined threshold value of about 50 mA, the charging of the battery “1” is completed, and the operation is switched to charging of the battery “3”. Then, when the charging of the battery “3” further proceeds, and the charge current is lowered to the predetermined threshold value of about 50 mA, the charging of the battery “3” is completed.

Therefore, as illustrated in the drawing, charging of the batteries “1”, “2”, and “3” is executed in the order of arrows A→E→B→C→F→I→D→G→J. If charging of the batteries “1”, “2”, and “3” is alternately executed, the time taken to fully charge all batteries does not change, but when charging is stopped before all batteries are fully charged, charging of each battery is fulfilled substantially equally, and therefore, the operation is more efficient.

### Seventh Embodiment

As another modified example of charge control, after the main charge is started, when the charge current value of a battery being charged is lower than the current value acquired from a battery not being charged, a battery to be charged may be switched after a fixed time elapses. Herein, the reason for setting the hysteresis of “a fixed time” is to stabilize charge control so that a battery to be charged will not be frequently switched.

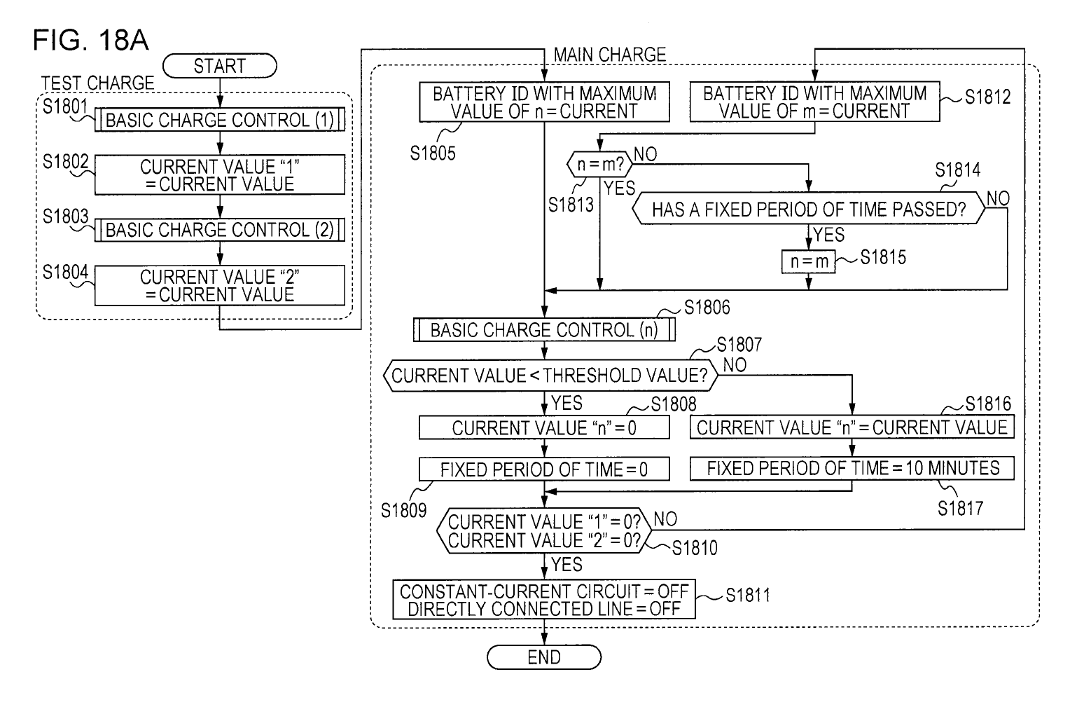

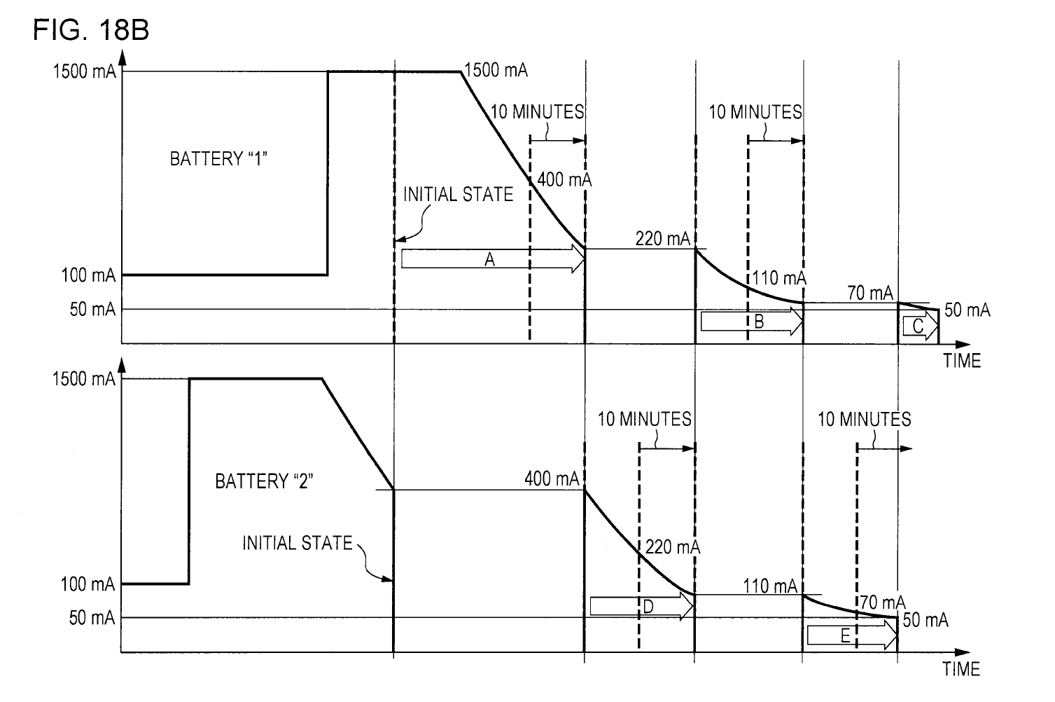

FIG. 18A shows a procedure of charge control by the control unit 128 of the main body of the digital camera 101 in the form of a flowchart according to a seventh embodiment of the present disclosure. As shown in the drawing, charge control is performed from the test charge to the main charge in order, but in the main charge, a battery to be charged is switched after a fixed time elapses since the charge current value of the battery being charged is lower than the current value acquired from the battery not being charged by a certain value or higher.

When charging is started, basic charge control for the battery “1” 109 is first performed (Step S1801), a charge current value “1” of the battery “1” 109 is acquired (Step S1802), subsequently, basic charge control is performed for the battery “2” 110 (Step S1803), and then a charge current value “2” of the battery “2” 110 is acquired (Step S1804). The procedure of the basic charge control is the same as that illustrated in FIG. 8.

Thereby, the test charge ends, and then the main charge starts.

In the main charge, first, when a battery ID of which the present charge current value is at the maximum is acquired, the battery ID is substituted for the variable n indicating a battery ID for performing the main charge (Step S1805). At this time, if there are two or more batteries having the same current value, the lowest battery ID is selected for the sake of convenience.

Next, basic charge control is performed for a battery “n” (Step S1806). The charging of the battery “n” proceeds, the potential difference between the power source voltage for charging and the battery voltage becomes small, and thereby the charge current value becomes lower. Then, if the charge current value of the battery “n” is lower than the predetermined threshold value stored in the control unit 128 (Yes in Step S1807), 0 is substituted for the current value “n” of the battery “n” (Step S1808), then completion of charging is indicated and 0 is set as a fixed time (Step S1809).

On the other hand, the charge current value of the battery “n” is not lower than the predetermined threshold value stored in the control unit 128 (No in Step S1807), the current value acquired in the basic charge control of Step S1806 is substituted for the current value “n” of the battery “n” (Step S1816), and a time of 10 minutes is set as a fixed time (Step S1817). The fixed time is a standby time until a battery to be charge is switched, but can be arbitrarily determined in accordance with a system.

If a battery ID of which the present charge current value is at the maximum is acquired when the current values of all batteries are not 0, in other words, when charging of all batteries is not completed (No in Step S1810), the battery ID is substituted for a variable m indicating a battery ID for performing the main charge (Step S1812). At this time, if there are two or more batteries having the same current value, the lowest battery ID is selected for the sake of convenience.

When m is equal to n, in other words, when the charge current of a battery “n” is still at the maximum (Yes in Step S1813), the process advances to Step S1806, and the charge operation of the battery “n” continues.

On the other hand, when m is not equal to n, in other words, the charge current of a battery “m” other than the battery “n” is at the maximum (No in Step S1813), subsequently, it is checked whether the fixed time set in Step S1817 has elapsed or not (Step S1814).

When the fixed time has not yet elapsed (No in Step S1814), the process advances to Step S1806, and the charge operation of the battery “n” continues. In regard to this operation, when the fixed time has elapsed after the charge current of the battery “m” other than the battery “n” is at the maximum (Yes in Step S1814), m is substituted for n to advance to Step S1806, and the charge operation is switched to the battery “m”.

Then, when charging of all batteries is completed (Yes in Step S1810), the state is set to be “disconnection on the constant-current circuit side and disconnection on the directly connected line side” (Step S1811), and thereby the charge control ends.

The timing chart of FIG. 18B exemplifies the performance of charge control for the battery “1” and the battery “2” which are in different states according to the procedure illustrated in FIG. 18A. Herein, it is assumed that a fixed time for switching a battery to be charged, that is, a time of 10 minutes is set as a hysteresis.

For the battery “1”, 1500 mA that is the maximum current of USB charge is acquired in the initial state. On the other hand, for the battery “2”, the charge current gradually decreases in the initial state, and 400 mA is acquired as the charge current “2” thereof. Thus, in the main charge, the battery “1” having the higher charge current is charged first.

When charging of the battery “1” proceeds, the potential difference between the charge voltage and the battery voltage becomes small, and the charge current, that is, the current value “1” gradually decreases. While the charge current is not lowered to the predetermined threshold value of about 50 mA, if a fixed time of 10 minutes is set as a hysteresis and the current value “1” of the battery “1” is greater than the current value “2” of the battery “2”, the charging of the battery “1” continues.

When the charging of the battery “1” further proceeds, the current value “1” thereof is lower than 400 mA that is the current value “2” of the battery “2”. Then, when the fixed time of 10 minutes further elapses, the charging of the battery “1” is stopped and charging is switched to the battery “2”. At this moment, the current value “1” of the battery “1” is set to be 220 mA.

When charging of the battery “2” proceeds, the charge current, that is, the current value “2” gradually decreases. While the charge current is not lowered to the predetermined threshold value of about 50 mA, if a fixed time of 10 minutes is set as a hysteresis, and the current value “2” of the battery “2” is greater than the current value “1” of the battery “1”, the charging of the battery “2” continues.

When the charging of the battery “2” further proceeds, the current value “2” is lower than 200 mA that is the current value “1” of the battery “1”. Then, when the fixed time of 10 minutes further elapses, the charging of the battery “2” is stopped and charging is switched to the battery “1”. At this moment, the current value “2” of the battery “2” is set to be 110 mA.

When charging of the battery “1” proceeds, the charge current, that is, the current value “1” gradually decreases. While the charge current is not lowered to the predetermined threshold value of about 50 mA, if a fixed time of 10 minutes is set as a hysteresis, and the current value “1” of the battery “1” is greater than the current value “2” of the battery “2”, the charging of the battery “1” continues.

When the charging of the battery “1” further proceeds, the current value “1” is lower than 110 mA that is the current value “2” of the battery “2”. Then, when the fixed time of 10 minutes further elapses, the charging of the battery “1” is stopped and charging is switched to the battery “2”. At this moment, the current value “1” of the battery “1” is set to be 70 mA.

When the charging of the battery “2” further proceeds, and the charge current is lowered to the predetermined threshold value of about 50 mA, the charging of the battery “2” is completed, and charging is switched to the battery “1” again. In addition, when the charging of the battery “1” further proceeds, and the charge current is lowered to the predetermined threshold value of about 50 mA, the charging of the battery “1” is also completed.

Therefore, as illustrated in the drawing, charging of the batteries “1” and “2” is executed in the order of arrows A→D→B→E→C. If charging of the batteries “1” and “2” is alternately executed, the time taken to fully charge all batteries does not change, but when charging is stopped before all batteries are fully charged, charging of each battery is fulfilled substantially equally, and therefore, the operation is more efficient.

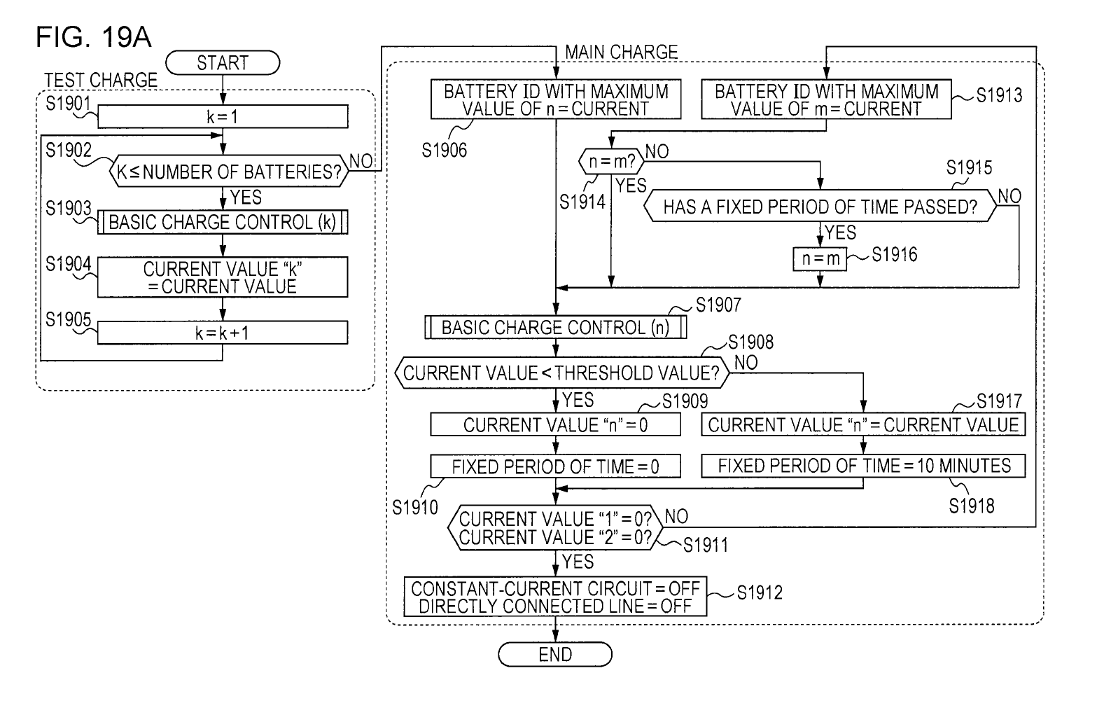

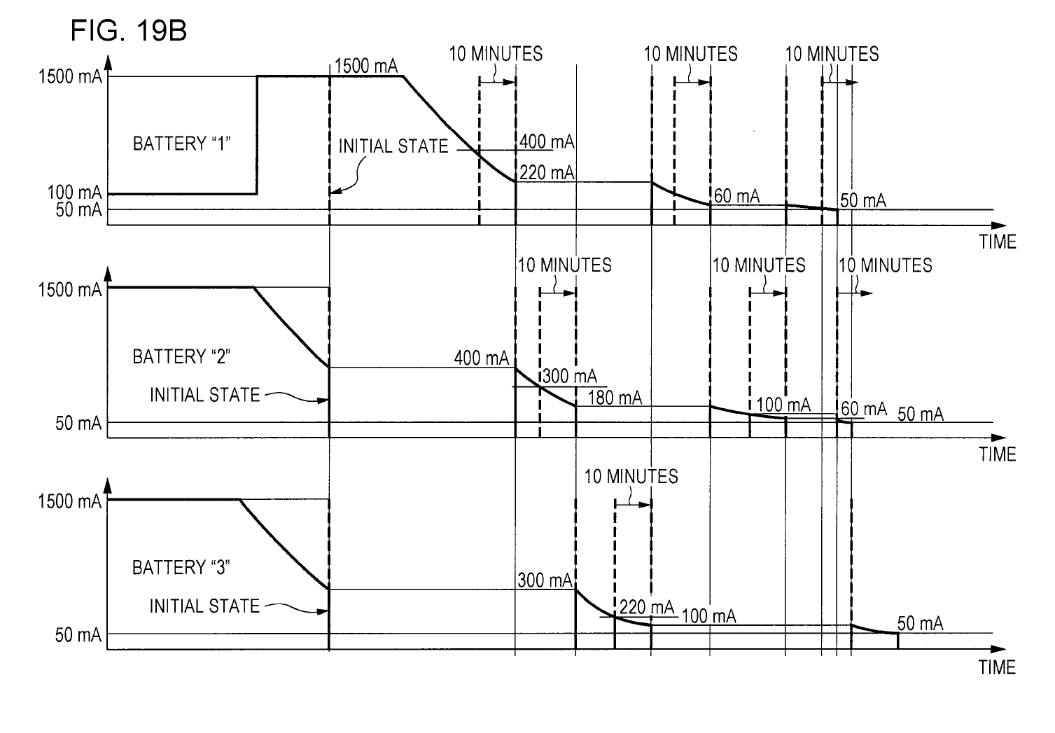

FIG. 19A shows a procedure of charge control by the control unit 128 of the main body of the digital camera 101 for an arbitrary number of batteries in the form of a flowchart according to the seventh embodiment of the present disclosure. As shown in the drawing, charge control is performed from the test charge to the main charge in order, but in the main charge, a battery to be charged is switched after a fixed time elapses since the charge current value of the battery being charged is lower than the current value acquired from the battery not being charged by a certain value or higher.

In the test charge, a process that an initial value 1 is substituted for a variable k for counting the number of batteries subject to the test charge (Step S1901), basic charge control is performed for a battery “k” (Step S1903), a charge current value “k” of the battery “k” is acquired (Step S1904), and k is augmented one by one (Step S1905) and is repeated until k reaches the number of batteries (Yes in Step S1902). The procedure of the basic charge control performed in Step S1903 is the same as shown in FIG. 8.

Then, when k reaches the number of batteries (No in Step S1902), the test charge is finished, and subsequently, the main charge is started.

In the main charge, first, when a battery ID of which the charge current value acquired in the test charge is at the maximum is acquired, the battery ID is substituted for the variable n indicating a battery ID for performing the main charge (Step S1906). At this time, if there are two or more batteries having the same current value, the lowest battery ID is selected for the sake of convenience.

Next, basic charge control is performed for a battery “n” (Step S1907). The charging of the battery “n” proceeds, the potential difference between the power source voltage for charging and the battery voltage becomes small, and thereby the charge current value becomes lower. Then, if the charge current value of the battery “n” is lower than the predetermined threshold value stored in the control unit 128 (Yes in Step S1908), 0 is substituted for the current value “n” of the battery “n” (Step S1909), then completion of charging is indicated and 0 is set as a fixed time (Step S1910).

On the other hand, the charge current value of the battery “n” is not lower than the predetermined threshold value stored in the control unit 128 (No in Step S1908), the current value acquired in the basic charge control of Step S1907 is substituted for the current value “n” of the battery “n” (Step S1917), and a time of 10 minutes is set as a fixed time (Step S1918). The fixed time is a standby time until a battery to be charged is switched, but can be arbitrarily determined in accordance with a system.

If a battery ID of which the present charge current value is at the maximum is acquired when the current values of all batteries are not 0, in other words, when charging of all batteries is not completed (No in Step S1911), the battery ID is substituted for a variable m indicating a battery ID for performing the main charge (Step S1913). At this time, if there are two or more batteries having the same current value, the lowest battery ID is selected for the sake of convenience.

When m is equal to n, in other words, when the charge current of a battery “n” is still at the maximum (Yes in Step S1914), the process advances to Step S1907, and the charge operation of the battery “n” continues.

On the other hand, when m is not equal to n, in other words, the charge current of a battery “m” other than the battery “n” is at the maximum (No in Step S1914), subsequently, it is checked whether the fixed time set in Step S1918 has elapsed or not (Step S1915).

When the fixed time has not yet elapsed (No in Step S1915), the process advances to Step S1907, and the charge operation of the battery “n” continues. In regard to this operation, when the fixed time has elapsed after the charge current of the battery “m” other than the battery “n” is at the maximum (Yes in Step S1915), m is substituted for n to advance to Step S1907, and the charge operation is switched to the battery “m”.

The charge operation described above is repeated until the charge values of all batteries is 0, in other words, until charging of all batteries is completed (No in Step S1911).

Then, when charging of all batteries is completed (Yes in Step S1911), the state is set to be “disconnection on the constant-current circuit side and disconnection on the directly connected line side” (Step S1912), and thereby the charge control ends.

The timing chart of FIG. 19B exemplifies the performance of charge control for three batteries “1”, “2”, and “3” according to the procedure illustrated in FIG. 19A. Herein, it is assumed that a fixed time of 10 minutes is set as a hysteresis.

From the test charge, the charge currents of the batteries “1”, “2”, and “3” in the initial state are acquired. As a result, 1500 mA that is the maximum current of USB charge is acquired as the charge current “1” of the battery “1”. In addition, the charge currents of the batteries “2” and “3” gradually decrease, and respective charge currents of 400 mA and 300 mA are acquire in the initial state. Thus, in the main charge, the battery “1” having the highest charge current value is charged first.

When charging of the battery “1” proceeds, the potential difference between the charge voltage and the battery voltage becomes small, and the charge current, that is, the current value “1” gradually decreases. While the charge current is not lowered to the predetermined threshold value of about 50 mA, if a fixed time of 10 minutes is set as a hysteresis. Then, the charging of the battery “1” continues until the current value “1” is greater than the current values “2” and “3” of the batteries “2” and “3”, or the fixed time elapses.

When the charging of the battery “1” further proceeds, the current value “1” thereof is lower than 400 mA that is the current value “2” of the battery “2”. Then, when the fixed time of 10 minutes further elapses, the charging of the battery “1” is stopped and charging is switched to the battery “2”. At this moment, the current value “1” of the battery “1” is set to be 220 mA.

When charging of the battery “2” proceeds, the charge current, that is, the current value “2” gradually decreases. While the charge current is not lowered to the predetermined threshold value of about 50 mA, a fixed time of 10 minutes is set as a hysteresis. Then, the charging of the battery “2” continues until the current value “2” is greater than the current values “1” and “3” of the batteries “1” and “3”, or the fixed time elapses.

When the charging of the battery “2” further proceeds, the current value “2” is lower than the current value “3” of the battery “3”. Then, when the fixed time of 10 minutes further elapses, the charging of the battery “2” is stopped and charging is switched to the battery “3”. At this moment, the current value “2” of the battery “2” is set to be 180 mA.

When charging of the battery “3” proceeds, the charge current, that is, the current value “3” gradually decreases. While the charge current is not lowered to the predetermined threshold value of about 50 mA, a fixed time of 10 minutes is set as a hysteresis. Then, the charging of the battery “3” continues until the current value “3” is greater than the current values “1” and “2” of the batteries “1” and “2”, or the fixed time elapses.

When the charging of the battery “3” further proceeds, the current value “3” is lower than the current value “1” of the battery “1”. Then, when the fixed time of 10 minutes further elapses, the charging of the battery “3” is stopped and charging is switched to the battery “1”. At this moment, the current value “3” of the battery “3” is set to be 100 mA.

When the charging of the battery “1” further proceeds, the charge current, that is, the current value “1” gradually decreases. While the charge current is not lowered to the predetermined threshold value of about 50 mA, a fixed time of 10 minutes is set as a hysteresis. Then, the charging of the battery “1” continues until the current value “1” is greater than the current values “2” and “3” of the batteries “2” and “3”, or the fixed time elapses.

When the charging of the battery “1” further proceeds, the current value “1” is lower than the current value “2” of the battery “2”. Then, when the fixed time of 10 minutes further elapses, the charging of the battery “1” is stopped and charging is switched to the battery “2”. At this moment, the current value “1” of the battery “1” is set to be 100 mA.

When the charging of the battery “2” further proceeds, the charge current, that is, the current value “2” gradually decreases. While the charge current is not lowered to the predetermined threshold value of about 50 mA, a fixed time of 10 minutes is set as a hysteresis. Then, the charging of the battery “2” continues until the current value “2” is greater than the current values “1” and “3” of the batteries “1” and “3”, or the fixed time elapses.

When the charging of the battery “2” further proceeds, the current value “2” is lower than the current values “1” and “3” of the batteries “1” and “3”. Then, when the fixed time of 10 minutes further elapses, the charging of the battery “2” is stopped and charging is switched to the battery “1”. The current values “1” and “3” are the same, but in this case, charging is switched to a battery having a lower battery ID. At this moment, the current value “2” of the battery “2” is set to be 60 mA.

When the charging of the battery “1” further proceeds, the charge current, that is, the current value “1” gradually decreases. While the charge current is not lowered to the predetermined threshold value of about 50 mA, a fixed time of 10 minutes is set as a hysteresis. Then, the charging of the battery “1” continues for the fixed time of 10 minutes even if the current value “1” is lower than the current value “2” of the battery “2”, and if the charge current is lowered to the predetermined threshold value of about 50 mA during the time, the charging of the battery “1” is completed. Then, charging is switched to the battery “2” having the highest current value at the time.

When the charging of the battery “2” further proceeds, and the charge current is lowered to the predetermined threshold value of about 50 mA, the charging of the battery “2” is also completed, and charging is switched to the battery “3” again. Then, when the charging of the battery “3” further proceeds, and the charge current is lowered to the predetermined threshold value of about 50 mA, the charging of the battery “3” is also completed.

As shown in the drawing, if charging of the batteries “1”, “2”, and “3” is alternately executed, the time taken to fully charge all batteries does not change, but when charging is stopped before all batteries are fully charged, charging of each battery is fulfilled substantially equally, and therefore, the operation is more efficient.

### Eighth Embodiment

In the procedure of the charge control illustrated in FIG. 7A, the charge order is determined by comparing the charge currents of the battery “1” 109 and the battery “2” 110. This is because, if a battery having a higher charge current is charged first, the charge current integrated value becomes great, which is efficient.

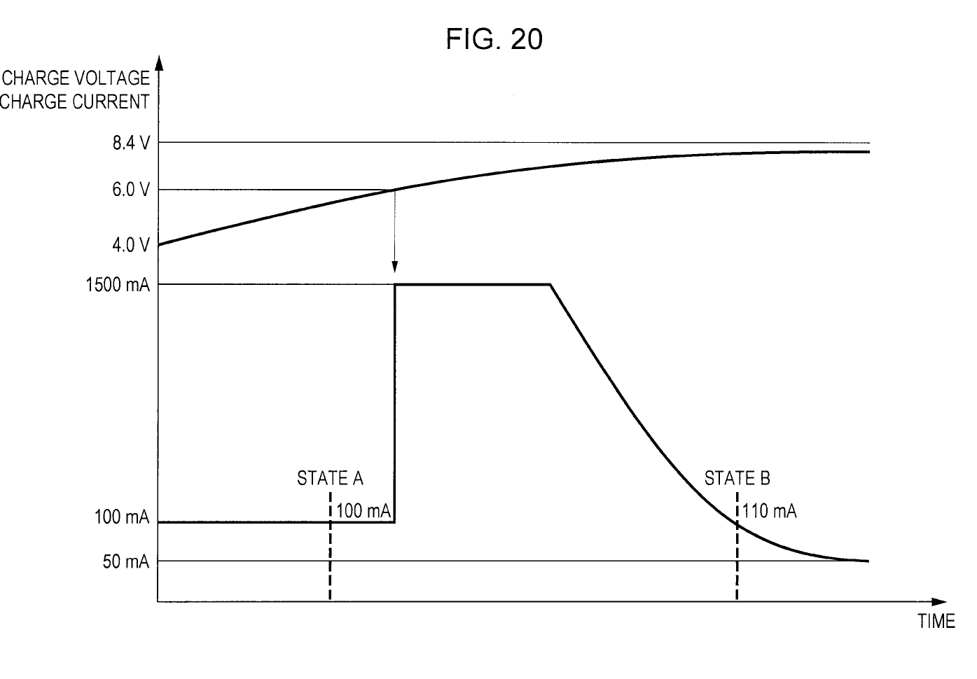

However, with reference to the charge characteristic of a lithium-ion battery illustrated in FIG. 20, the charge currents are substantially the same during the time of constant current charge that is equivalent to the initial stage of charge and the time close to the end of charge in which the charge current is lowered. In the example of the drawing, whereas the charge current is 100 mA in the state A that is equivalent to the initial state of charge, the charge current is 110 mA in the state B close to the end of charge, and thus, the charge currents are substantially the same.

In such a case, even if the charge currents are substantially the same, charging a battery first in the state A equivalent to the initial state of charging is efficient due to the fact that the charge current integrated value becomes high. With reference to FIG. 20 again, the charge voltage of the lithium-ion battery gradually increases according to a charge time (or a charge capacity). Thus, in addition to charge currents, the state of charge can be ascertained by comparing charge voltages.

Therefore, when the charge currents of the battery “1” 109 and the battery “2” 110 are substantially the same, the order of charge may be determined using voltage information of each battery. For example, if the difference between the charge currents of the battery “1” 109 and the battery “2” 110 is equal to or lower than 50 mA, the order of charge is determined further using the voltage values of the respective batteries. In this case, when the test charge is respectively performed for each battery, the charge voltage values are acquired together. For example, the control unit 128 of the main body of the digital camera 101 measures the charge voltages using the AD port 132, and stores the values therein.

When one battery has a charge current of 100 mA in the state A in which the charge voltage is low and constant-current charge is performed, and the other battery has a charge current of 110 mA in the state B close to full charge, the difference of the charge currents is 10 mA, which is lower than 50 mA, and thus, the order of charge will not be determined based only on the sizes of charge currents. If the charge is controlled to be performed in the order of batteries having lower charge voltages, the battery in the state A is charged first, which is more efficient.

When the charge currents of the battery “1” 109 and the battery “2” 110 are substantially the same, charging in the order of batteries having lower charge voltage is equivalent to charging batteries having lower current integrated values (that is, lower battery capacities).

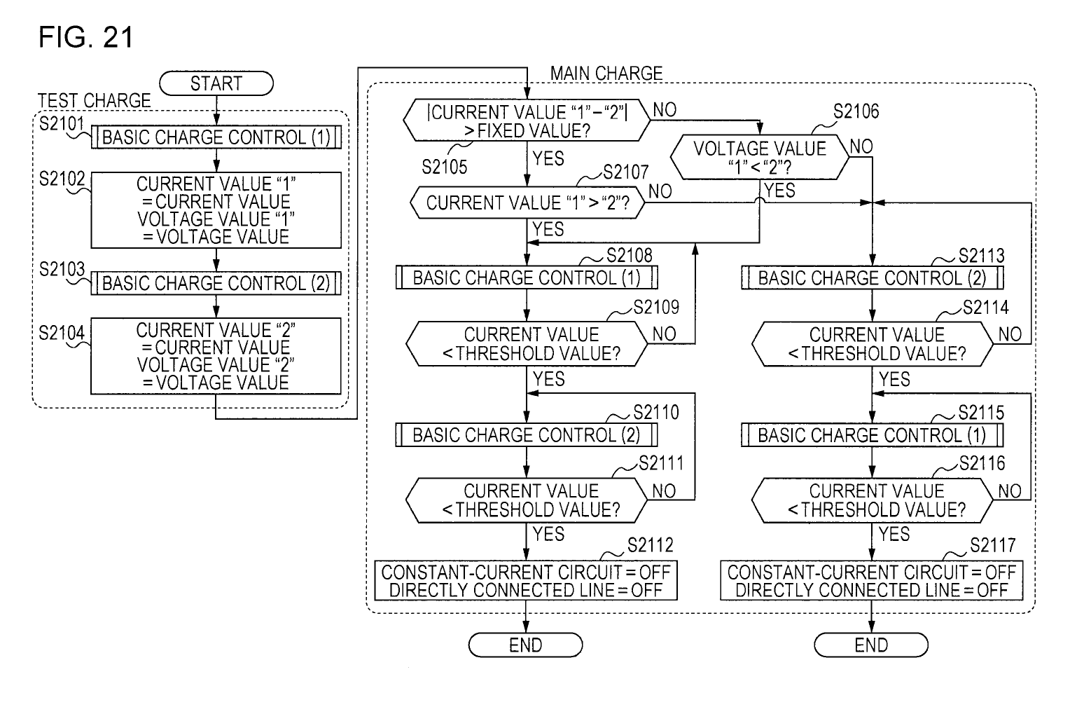

FIG. 21 illustrates a procedure of charge control by the control unit 128 of the main body of the digital camera 101 in the form of a flowchart according to an eighth embodiment of the present disclosure. As illustrated in the drawing, charge control is performed from the test charge to the main charge in order. If the difference of charge currents is equal to or lower than a fixed value, the order of charge is determined based on the voltage values of respective batteries.

When charging is started, basic charge control is first performed for the battery “1” 109 (Step S2101), and a charge current value “1” and a charge voltage value “1” of the battery “1” 109 are acquired (Step S2102). Subsequently, basic charge control is performed for the battery “2” 110 (Step S2103), and a charge current value “2” and a charge voltage value “2” of the battery “2” 110 are acquired (Step S2104).

Thereby, the test charge ends, and then the main charge starts.

In the main charge, first, it is checked whether the difference between the charge current value “1” of the battery “1” 109 and the charge current value “2” of the battery “2” 110 acquired in the test charge exceeds a predetermined value (for example 50 mA) or not (Step S2105).

When the difference between the charge current value “1” of the battery “1” 109 and the charge current value “2” of the battery “2” 110 is equal to or lower than the predetermined value (No in Step S2105), the sizes of the charge voltage value “1” of the battery “1” 109 and the charge voltage value “2” of the battery “2” 110 acquired in the test charge are compared (Step S2106).

In addition, when the difference between the charge current value “1” of the battery “1” 109 and the charge current value “2” of the battery “2” 110 exceeds the predetermined value (Yes in Step S2105), the sizes of the charge current value “1” and the charge current value “2” are compared (Step S2107).

When the voltage value “1” is lower (Yes in Step S2106) or when the current value “1” is greater (Yes in Step S2107), basic charge control is performed for the battery “1” 109 (Step S2108). The basic charge control for the battery “1” 109 continues until charging of the battery “1” 109 proceeds, the potential difference between the power source voltage for charging and the battery voltage becomes small and thereby the charge current value is lower than a predetermined threshold value stored in the control unit 128 (No in Step S2109).

Then, if the charge current value of the battery “1” 109 is lower than the predetermined threshold value (Yes in Step S2109), the charging of the battery “1” 109 is determined to be completed, and subsequently, basic charge control is performed for the battery “2” 110 (Step S2110). The basic charge control for the battery “2” 110 continues until charging of the battery “2” 110 proceeds, the potential difference between the power source voltage for charging and the battery voltage becomes small and thereby the charge current value is lower than the predetermined threshold value (No in Step S2111).

Then, when the charge current value of the battery “2” 100 is lower than the predetermined threshold value (Yes in Step S2111), and charging for both batteries ends, the control unit 128 causes the switch 127 to set the state of “disconnection on the constant-current circuit side and disconnection on the directly connected line side” using the signal line 129 (Step S2112), and then the charge control ends.

On the other hand, when the voltage value “2” is lower (No in Step S2106), or when the current value “2” is greater (No in Step S2107), basic charge control for the battery “2” 110 is performed (Step S2113). The basic charge control for the battery “2” 110 continues until charging of the battery “2” 110 proceeds, the potential difference between the power source voltage for charging and the battery voltage becomes small, and thereby, the charge current value is lower than the predetermined threshold value (No in Step S2114).

Then, when the charge current value of the battery “2” 110 is lower than the predetermined threshold value (Yes in Step S2114), the charging of the battery “2” 110 is determined to be finished and subsequently, basic charge control for the battery “1” 109 is performed (Step S2115). The basic charge control for the battery “1” 109 continues until charging of the battery “1” 109 proceeds, the potential difference between the power source voltage for charging and the battery voltage becomes small, and thereby, the charge current value is lower than the predetermined threshold value (No in Step S2116).

Then, when the charge current value of the battery “1” 109 is lower than the predetermined threshold value (Yes in Step S2116), and charging for both batteries ends, the control unit 128 causes the switch 127 to set the state of “disconnection on the constant-current circuit side and disconnection on the directly connected line side” using the signal line 129 (Step S2117), and then the charge control ends.

### Ninth Embodiment

When charging of a lithium-ion battery is started, the temperature of the battery increases due to Joule heat caused by the internal impedance of the battery. In addition, when the temperature of the battery is high, it is not possible to run a high charge current in order to satisfy safety regulations such as the electrical appliances and material safety act. Therefore, if the temperature is high when charging is started, even if the charge current is high in the first stage, the temperature shortly exceeds the control threshold value (reference temperature value) based on the safety regulations, causing a situation in which the charge current has to be suppressed, and therefore, the efficiency of charging deteriorates.

Thus, charging may be first performed from a battery having a lower temperature among batteries having the temperatures higher than the reference value, ignoring that the charge current values acquired during test charge.

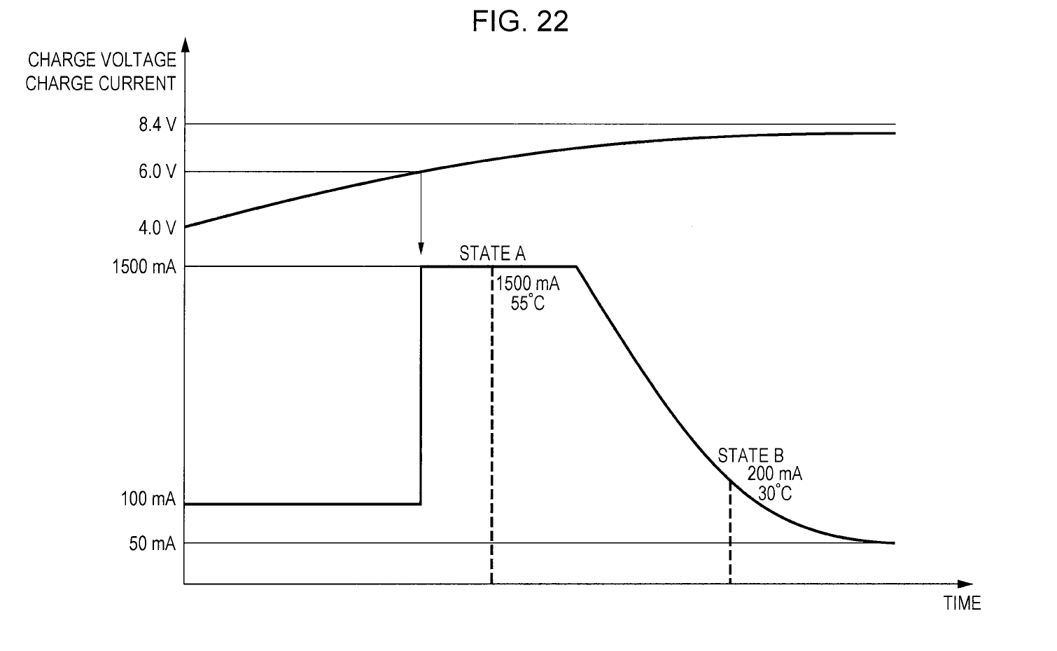

For example, when temperature of a battery is 50° C. that is close to the temperature threshold value of 60° C. stipulated in the safety regulations, charging will be performed for the other battery. In the example illustrated in FIG. 22, in the test charge, whereas the battery “1” of the one side is in the state A and the charge current thereof is set to be 1500 mA and the temperature thereof is set to be 55° C., the battery “2” of the other side is in the state B, and the charge current thereof is set to be 200 mA and the temperature thereof is set to be 30° C. Herein, if it is assumed that the reference temperature value for the safety regulations is set to be 50° C., the temperature of the battery “1” exceeds the reference temperature value, and thus, it is difficult to determined the order of charging based on the charge currents, but charging will be performed from the battery “2” of which the temperature does not exceed the reference temperature value.

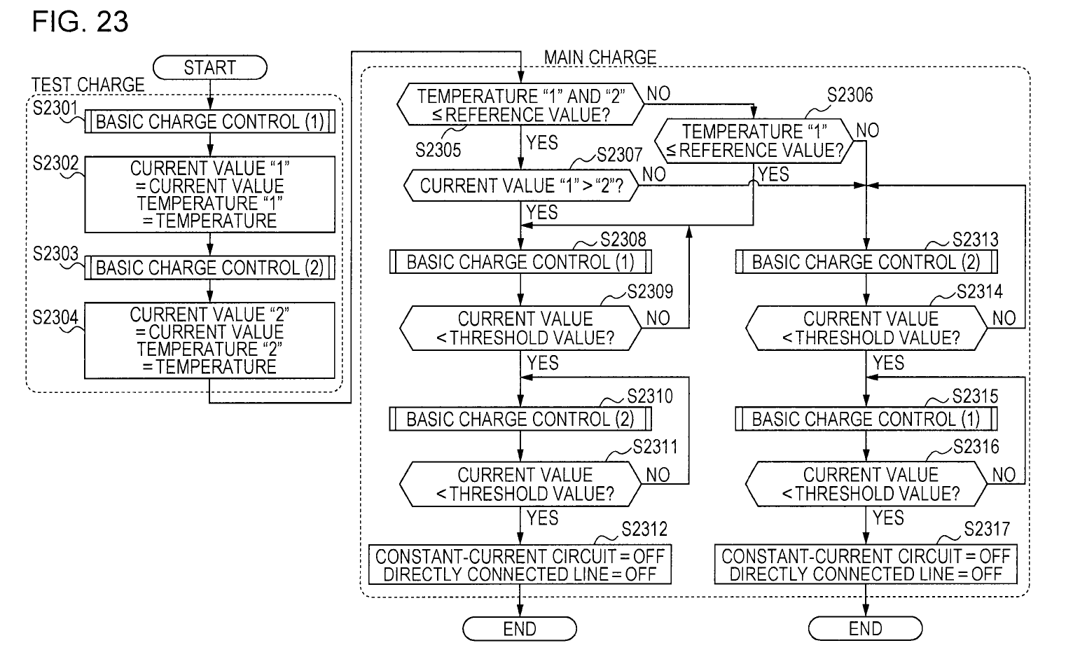

FIG. 23 illustrates a procedure of charge control by the control unit 128 of the main body of the digital camera 101 in the form of a flowchart according to a ninth embodiment of the present disclosure. As illustrated, charge control is performed from test charge to main charge in order. Only when the temperature of a battery does not exceed a reference value, the order of charging is determined based on the charge current.

When charging is started, basic charge control is first performed for the battery “1” 109 (Step S2301), and the charge current value “1” and the temperature “1” of the battery “1” 109 are acquired (Step S2302). Subsequently, basic charge control is performed for the battery “2” 110 (Step S2303), and the charge current value “2” and the temperature “2” of the battery “2” 110 are acquired (Step S2304).

Thereby, the test charge is finished, and then the main charge is started.

In the main charge, it is first checked whether the temperature “1” of the battery “1” 109 and the temperature “2” of the battery “2” 110 are equal to or lower than the reference temperature value or not (Step S2305).

Then, when both of the temperature “1” of the battery “1” 109 and the temperature “2” of the battery “2” 110 are equal to or lower than the reference temperature value (Yes in Step S2305), and when the charge current “1” of the battery “1” 109 is greater (Yes in Step S2307), or only the temperature “1” of the battery “1” 109 is equal to or lower than the reference temperature value (Yes in Step S2306), basic charge control is performed for the battery “1” 109 (Step S2308). The basic charge control of the battery “1” 109 continues until the charging of the battery “1” 109 proceeds, the potential difference between the power source voltage for charging and the battery voltage becomes small, and thereby the charge current value is lower than the predetermined threshold value stored in the control unit 128 (No in Step S2309).

Then, when the charge current value of the battery “1” 109 is lower than the predetermined threshold value (Yes in Step S2309), the charging of the battery “1” 109 is determined to be finished and subsequently, basic charge control for the battery “2” 110 is performed (Step S2310). The basic charge control for the battery “2” 110 continues until charging of the battery “2” 110 proceeds, the potential difference between the power source voltage for charging and the battery voltage becomes small, and thereby, the charge current value is lower than the predetermined threshold value (No in Step S2311).

Then, when the charge current value of the battery “2” 110 is lower than the predetermined threshold value (Yes in Step S2311), and charging for both batteries ends, the control unit 128 causes the switch 127 to set the state of “disconnection on the constant-current circuit side and disconnection on the directly connected line side” using the signal line 129 (Step S2312), and then the charge control ends.

On the other hand, when both of the temperature “1” of the battery “1” 109 and the temperature “2” of the battery “2” 110 are equal to or lower than the reference temperature value (Yes in Step S2305), and when the charge current “2” of the battery “2” 110 is greater (No in Step S2307), or only the temperature “2” of the battery “2” 110 is equal to or lower than the reference temperature value (No in Step S2306), basic charge control is performed for the battery “2” 110 (Step S2313). The basic charge control of the battery “2” 110 continues until the charging of the battery “2” 110 proceeds, the potential difference between the power source voltage for charging and the battery voltage becomes small, and thereby the charge current value is lower than the predetermined threshold value (No in Step S2314).

Then, when the charge current value of the battery “2” 110 is lower than the predetermined threshold value (Yes in Step S2314), the charging of the battery “2” 110 is determined to be finished and subsequently, basic charge control for the battery “1” 109 is performed (Step S2315). The basic charge control for the battery “1” 109 continues until charging of the battery “1” 109 proceeds, the potential difference between the power source voltage for charging and the battery voltage becomes small, and thereby, the charge current value is lower than the predetermined threshold value (No in Step S2316).

Then, when the charge current value of the battery “1” 109 is lower than the predetermined threshold value (Yes in Step S2316), and charging for both batteries ends, the control unit 128 causes the switch 127 to set the state of “disconnection on the constant-current circuit side and disconnection on the directly connected line side” using the signal line 129 (Step S2317), and then the charge control ends.

### Tenth Embodiment

When one battery is being discharged and the power source is supplied to the main body of the digital camera 101, charging may be first performed for the other battery that has not been discharged.

When the main body of the digital camera 101 is started without being connected to the USB cable 111, the camera is operated receiving power supply from either of the battery “1” 109 or the battery “2” 110 in a state in which photographing is possible. In this state, if charging is performed by connecting the main body of the digital camera 101 to the USB cable 111, there is concern that it is difficult to accurately measure the charge current and thus charging is not normally controlled according to the procedure as illustrated in FIG. 7A. For this reason, charging will be performed from a battery not receiving the power supply.

### Eleventh Embodiment

In the procedure of the charge control illustrated in FIG. 7A, the order of charging is determined by simply comparing the charge currents of the battery “1” 109 and the battery “2” 110. This is because, if a battery having a higher charge current is charged first, the charge current integrated value becomes great, which is efficient.

Herein, when the charge currents of the battery “1” 109 and the battery “2” 110 are substantially the same, charging may be performed in the order of batteries having higher full-charge capacity. For example, if the difference between the charge currents of the battery “1” 109 and the battery “2” 110 is 50 mA or lower, the order of charging is further determined based on the full-charge capacity of each battery. If charging is performed from a battery having a full-charge capacity with the full capability of power feeding, a battery for which a longer time is taken for charging with the full capability of power feeding is charged first, and therefore, more efficient charging can be realized.

The microcomputer 155 inside the battery “1” 109 and the microcomputer 170 inside the battery “2” 110 are designed to respectively store in advance full-charge capacities of the batteries before shipping. In such a case, the control unit 128 of the main body of the digital camera 101 can acquire the full-charge capacities of the batteries through communication using the C terminal thereof.

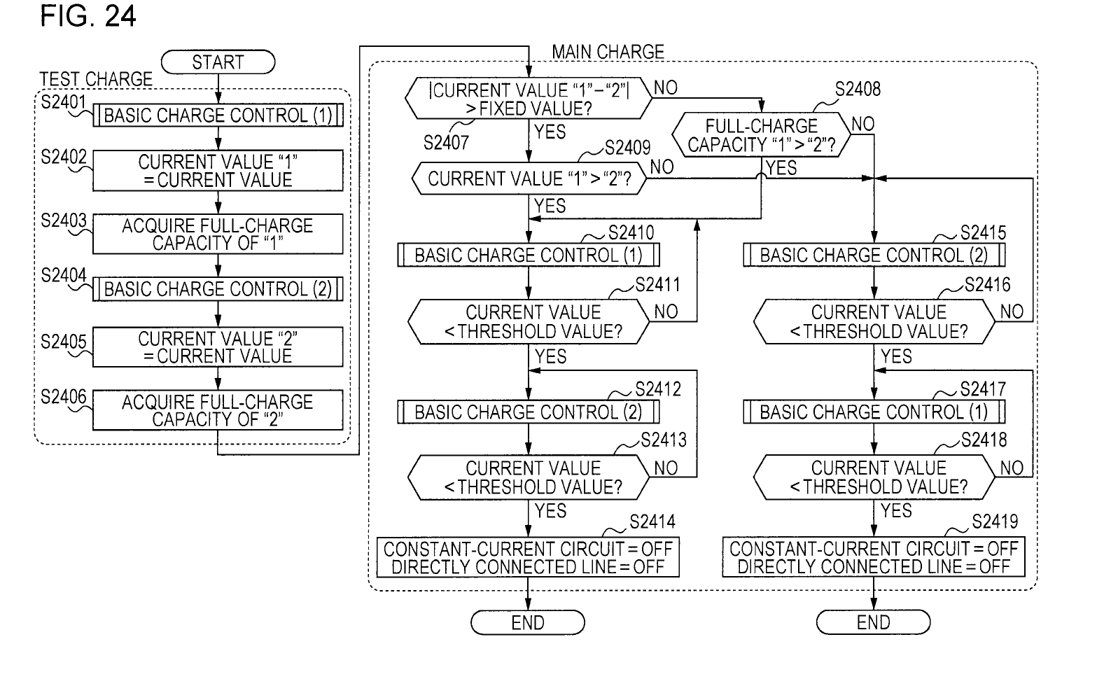

FIG. 24 illustrates a procedure of charge control by the control unit 128 of the main body of the digital camera 101 in the form of a flowchart according to an eleventh embodiment of the present disclosure. As illustrated, charge control is performed from the test charge to the main charge in order. When the difference between charge currents is equal to or lower than a fixed value, the order of charging is determined based on the full-charge capacity of each battery.

When charging is started, basic charge control is first performed for the battery “1” 109 (Step S2401), and the charge current value “1” of the battery “1” 109 is acquired (Step S2402), and the full-charge capacity “1” is acquired from the microcomputer 155 of the battery “1” 109 (Step S2403). Subsequently, basic charge control is performed for the battery “2” 110 (Step S2404), and then the charge current value “2” of the battery “2” 110 is acquired (Step S2405) and the full-charge capacity “2” is acquired from the microcomputer 170 of the battery “2” 110 (Step S2406).

Thereby, the test charge is finished, and then the main charge is started.

In the main charge, it is first checked whether the difference between the charge current value “1” of the battery “1” 109 and the charge current value “2” of the battery “2” 110 acquired in the test charge exceeds a predetermined value (for example, 50 mA) or not (Step S2407).

Then, when the difference of the charge current value “1” of the battery “1” 109 and the charge current value “2” of the battery “2” 110 is equal to or lower than the predetermined value (No in Step S2407), the sizes of the full-charge capacity “1” of the battery “1” 109 and the full-charge capacity “2” of the battery “2” 110 acquired in the test charge are compared (Step S2408).

In addition, when the difference between the charge current value “1” of the battery “1” 109 and the charge current value “2” of the battery “2” 110 exceeds the predetermined value (Yes in Step S2407), the sizes of the charge current value “1” and the charge current value “2” are compared (Step S2409).

When the full-charge capacity “1” is greater (Yes in Step S2408), or when the current value “1” is greater (Yes in Step S2409), basic charge control is performed for the battery “1” 109 (Step S2410). The basic charge control for the battery “1” 109 continues until charging of the battery “1” 109 proceeds, the potential difference between the power source voltage for charging and the battery voltage becomes small, and thereby, the charge current value is lower than the predetermined threshold value stored in the control unit 128 (No in Step S2411).

Then, when the charge current value of the battery “1” 109 is lower than the predetermined threshold value (Yes in Step S2411), the charging of the battery “1” 109 is determined to be completed, and subsequently, basic charge control is performed for the battery “2” 110 (Step S2412). The basic charge control for the battery “2” 110 continues until charging of the battery “2” 110 proceeds, the potential difference between the power source voltage for charging and the battery voltage becomes small, and thereby, the charge current value is lower than the predetermined threshold value (No in Step S2413).

Then, when the charge current value of the battery “2” 110 is lower than the predetermined threshold value (Yes in Step S2413), and charging of both batteries ends, the control unit 128 causes the switch 127 to set the state of “disconnection on the constant-current circuit side and disconnection on the directly connected line side” using the signal line 129 (Step S2414), and then the charge control ends.

On the other hand, when the full-charge capacity “2” is greater (No in Step S2408), or when the charge current “2” is greater (No in Step S2409), basic charge control is performed for the battery “2” 110 (Step S2415). The basic charge control of the battery “2” 110 continues until the charging of the battery “2” 110 proceeds, the potential difference between the power source voltage for charging and the battery voltage becomes small, and thereby the charge current value is lower than the predetermined threshold value (No in Step S2416).

Then, when the charge current value of the battery “2” 110 is lower than the predetermined threshold value (Yes in Step S2416), the charging of the battery “2” 110 is determined to be finished and subsequently, basic charge control for the battery “1” 109 is performed (Step S2417). The basic charge control for the battery “1” 109 continues until charging of the battery “1” 109 proceeds, the potential difference between the power source voltage for charging and the battery voltage becomes small, and thereby, the charge current value is lower than the predetermined threshold value (No in Step S2418).

Then, when the charge current value of the battery “1” 109 is lower than the predetermined threshold value (Yes in Step S2418), and charging for both batteries ends, the control unit 128 causes the switch 127 to set the state of “disconnection on the constant-current circuit side and disconnection on the directly connected line side” using the signal line 129 (Step S2419), and then the charge control ends.

### Twelfth Embodiment

In the procedure of the charge control illustrated in FIG. 7A, the order of charging is determined by simply comparing the charge currents of the battery “1” 109 and the battery “2” 110. This is because, if a battery having a higher charge current is charged first, the charge current integrated value becomes great, which is efficient.

Herein, when the charge currents of the battery “1” 109 and the battery “2” 110 are substantially the same, charging may be performed in the order of batteries having a fewer number of charging and discharging times. For example, if the difference between the charge currents of the battery “1” 109 and the battery “2” 110 is 50 mA or lower, the order of charging is further determined based on the number of charging and discharging times of each battery. If charging is performed from a battery having a fewer number of times of charging and discharging with the full capability of power feeding, a battery for which a longer time is taken for charging with the full capability of power feeding is charged first, and therefore, more efficient charging can be realized. Further, by selecting a less deteriorated battery, the progress of battery deterioration can be suppressed as a whole.

The microcomputer 155 inside the battery “1” 109 retains the value obtained by integrating charge currents measured by the current detection resistor 153, and the value obtained by augmenting the number of charging times whenever the battery is fully charged to capacity. In the same manner, the microcomputer 170 inside the battery “2” 110 retains the value obtained by integrating charge currents measured by the current detection resistor 168, and the value obtained by augmenting the number of charging times whenever the battery is fully charged to capacity. Then, the control unit 128 of the main body of the digital camera 101 can acquire the number of charging and discharging times of the batteries through communication using the C terminal thereof.

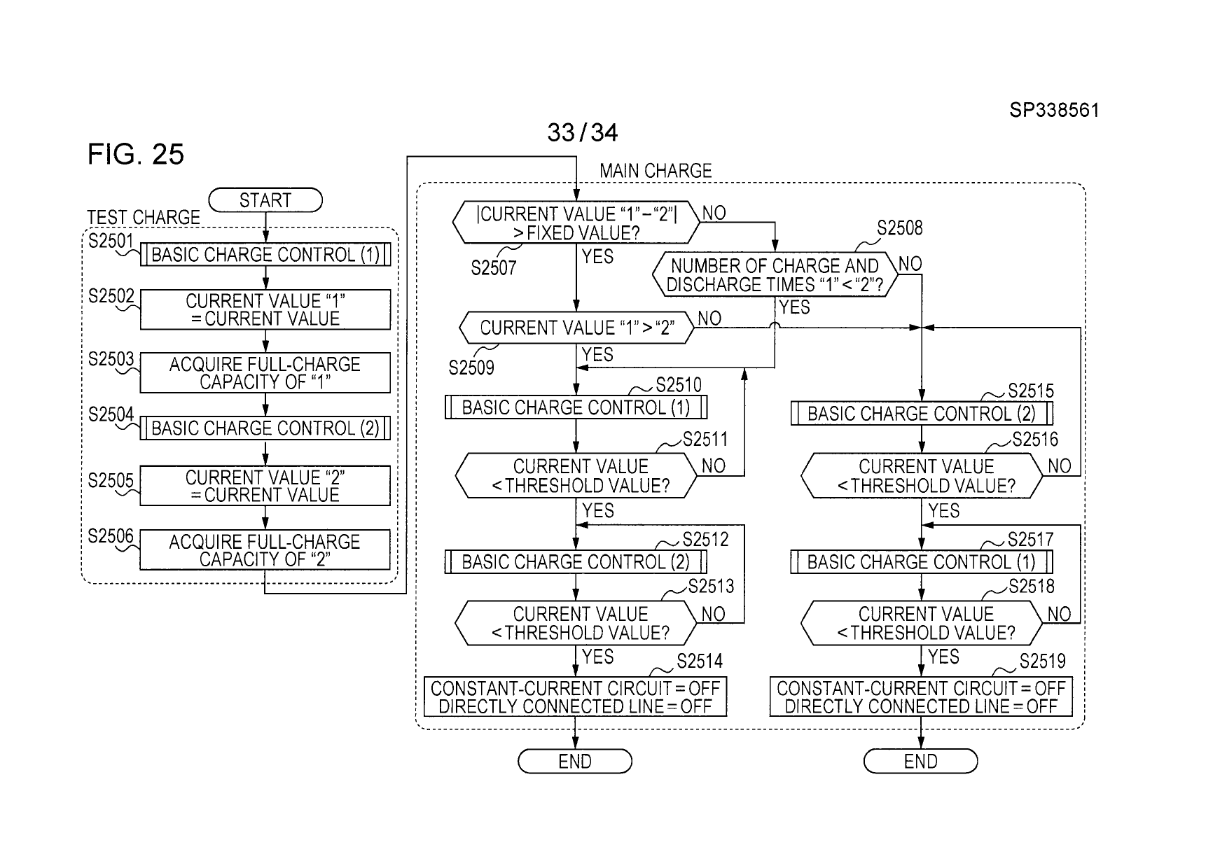

FIG. 25 illustrates a procedure of charge control by the control unit 128 of the main body of the digital camera 101 in the form of a flowchart according to a twelfth embodiment of the present disclosure. As illustrated, charge control is performed from the test charge to the main charge in order. When the difference between charge currents is equal to or lower than a fixed value, the order of charging is determined based on the number of charging and discharging times of each battery.

When charging is started, basic charge control is first performed for the battery “1” 109 (Step S2501), and the charge current value “1” of the battery “1” 109 is acquired (Step S2502), and the number of charging and discharging times “1” is acquired from the microcomputer 155 of the battery “1” 109 (Step S2503). Subsequently, basic charge control is performed for the battery “2” 110 (Step S2504), and then the charge current value “2” of the battery “2” 110 is acquired (Step S2505) and the number of charging and discharging times “2” is acquired from the microcomputer 170 of the battery “2” 110 (Step S2506).

Thereby, the test charge is finished, and then the main charge is started.

In the main charge, it is first checked whether the difference of the charge current value “1” of the battery “1” 109 and the charge current value “2” of the battery “2” 110 acquired in the test charge exceeds a predetermined value (for example, 50 mA) or not (Step S2507).

When the difference of the charge current value “1” of the battery “1” 109 and the charge current value “2” of the battery “2” 110 is equal to or lower than the predetermined value (No in Step S2507), the sizes of the number of charging and discharging times “1” of the battery “1” 109 and the number of charging and discharging times “2” of the battery “2” 110 acquired in the test charge are compared (Step S2508).

In addition, when the difference between the charge current value “1” of the battery “1” 109 and the charge current value “2” of the battery “2” 110 exceeds the predetermined value (Yes in Step S2507), the sizes of the charge current value “1” and the charge current value “2” are compared (Step S2509).

When the number of charging and discharging times “1” is smaller (Yes in Step S2508), or when the current value “1” is greater (Yes in Step S2509), basic charge control is performed for the battery “1” 109 (Step S2510). The basic charge control for the battery “1” 109 continues until charging of the battery “1” 109 proceeds, the potential difference between the power source voltage for charging and the battery voltage becomes small, and thereby, the charge current value is lower than the predetermined threshold value stored in the control unit 128 (No in Step S2511).

Then, when the charge current value of the battery “1” 109 is lower than the predetermined threshold value (Yes in Step S2511), the charging of the battery “1” 109 is determined to be completed, and subsequently, basic charge control is performed for the battery “2” 110 (Step S2512). The basic charge control for the battery “2” 110 continues until charging of the battery “2” 110 proceeds, the potential difference between the power source voltage for charging and the battery voltage becomes small, and thereby, the charge current value is lower than the predetermined threshold value (No in Step S2513).

Then, when the charge current value of the battery “2” 110 is lower than the predetermined threshold value (Yes in Step S2513), and charging of both batteries ends, the control unit 128 causes the switch 127 to set the state of “disconnection on the constant-current circuit side and disconnection on the directly connected line side” using the signal line 129 (Step S2514), and then the charge control ends.

On the other hand, when the number of charging and discharging times “2” is greater (No in Step S2508), or when the current value “2” is greater (No in Step S2509), basic charge control is performed for the battery “2” 110 (Step S2515). The basic charge control of the battery “2” 110 continues until the charging of the battery “2” 110 proceeds, the potential difference between the power source voltage for charging and the battery voltage becomes small, and thereby the charge current value is lower than the predetermined threshold value (No in Step S2516).

Then, when the charge current value of the battery “2” 110 is lower than the predetermined threshold value (Yes in Step S2516), the charging of the battery “2” 110 is determined to be finished and subsequently, basic charge control for the battery “1” 109 is performed (Step S2517). The basic charge control for the battery “1” 109 continues until charging of the battery “1” 109 proceeds, the potential difference between the power source voltage for charging and the battery voltage becomes small, and thereby, the charge current value is lower than the predetermined threshold value (No in Step S2518).

Then, when the charge current value of the battery “1” 109 is lower than the predetermined threshold value (Yes in Step S2518), and charging for both batteries ends, the control unit 128 causes the switch 127 to set the state of “disconnection on the constant-current circuit side and disconnection on the directly connected line side” using the signal line 129 (Step S2519), and then the charge control ends.

As a modified example of the present embodiment, when the charge currents of the battery “1” 109 and the battery “2” 110 are substantially the same, charging may be performed in the order of batteries having the latest production dates. If charging is performed from a battery having the latest production date with the full capability of power feeding, a battery for which a longer time is taken for charging with the full capability of power feeding is charged first, and therefore, more efficient charging can be realized.

In addition, as another modified example of the present embodiment, when the charge currents of the battery “1” 109 and the battery “2” 110 are substantially the same, charging may be performed in the order of batteries of which the final dates of use are earlier. If charging is performed from a battery of which the final date of use is earlier with the full capability of power feeding, a battery for which a longer time is taken for charging with the full capability of power feeding is charged first, and therefore, more efficient charging can be realized.

In this manner, if charge control is performed for two or more batteries using the technology disclosed in the present disclosure, charging is performed in the order of from a battery in the normal state to a battery of which a protective circuit is working due to the low voltage, and therefore, efficient charging can be realized.

In addition, if charge control is performed for two or more batteries using the technology disclosed in the present disclosure, charging is performed in the order of from a battery in the normal state to a battery almost fully charged, and therefore efficient charge can be realized. In this case, there is also another effect of hindering further progress of deterioration that may be caused by performing repetitive charging only for a battery that has already been almost fully charged.

In addition, if charge control is performed for two or more batteries using the technology disclosed in the present disclosure, charging is performed in the order of from a battery in the normal state to a battery at a lower temperature, and therefore efficient charge can be realized.

In addition, if charge control is performed for two or more batteries using the technology disclosed in the present disclosure, charging is performed in the order of from a battery in the normal state to a battery that further deteriorates, and therefore efficient charge can be realized. In this case, there is also another effect of hindering further progress of deterioration that may be caused by performing repetitive charging only for a battery that has already deteriorated.

In addition, if charge control is performed for two or more batteries using the technology disclosed in the present disclosure, charging is performed in the order of from an assembled battery having a large number of parallel cells to an assembled battery having a small number of parallel cells, and therefore efficient charge can be realized.

In addition, if charge control is performed for two or more batteries using the technology disclosed in the present disclosure, charging is performed in the order of from a battery in the normal state to a battery in a temperature state subject to be regulated by a safety standard, and therefore efficient charge can be realized.

Note that the technology disclosed in the present disclosure can also be configured as below.

(1) A charge control device that includes a current acquisition unit that acquires a charge current value of each battery, and a main charge unit that performs the main charge for each battery based on the charge current value acquired by the current acquisition unit.

(2) The charge control device described in (1) above in which the main charge unit performs the main charge for each battery in the order of from the highest charge current value.

(3) The charge control device described in (1) above in which, after a battery selected for the main charge based on a charge current value is fully charged, the main charge unit performs the main charge for a remaining battery based on a charge current value.

(4) The charge control device described in (1) above in which the current acquisition unit acquires each of the charge current values by performing the test charge for each battery only for a short period of time.

(5) The charge control device described in (1) above that is an electronic device using discharged currents from each battery as a power source.

(6) The charge control device described in (1) above in which the main charge unit switches a battery to be charged when the charge current value of a battery being charged decreases and becomes lower than the current value acquired from a battery not being charged by a fixed value or higher.

(7) The charge control device described in (1) above in which the main charge unit switches a battery to be charged when the charge current value of a battery being charged decreases, and becomes lower than the current value acquired from a battery not being charged, and then a fixed period of time elapses.

(8) The charge control device described in (1) above that further includes a voltage acquisition unit that acquires a voltage value of each battery, in which, when the difference between charge current values of each battery acquired by the current acquisition unit is equal to or lower than a fixed value, the main charge unit performs the main charge in the order of batteries having lower voltage values acquired by the voltage acquisition unit.

(9) The charge control device described in (1) above that further includes a temperature acquisition unit that acquires the temperature of each battery, in which the main charge unit performs the main charge for each battery in the order of from the highest charge current value, excluding a battery of which the temperature acquired by the temperature acquisition unit exceeds a reference value.

(10) The charge control device described in (1) above that further includes a full-charge capacity acquisition unit that acquires the full-charge capacity of each battery, in which, when the difference between the charge current values of batteries acquired by the current acquisition unit is equal to or lower than a fixed value, the main charge unit performs the main charge in the order of batteries having larger full-charge capacities acquired by the full-charge capacity acquisition unit.

(11) The charge control device described in (1) above that further includes a number of charging and discharging times acquisition unit that acquires the number of charging and discharging times of each battery, in which, when the difference between the charge current values of batteries acquired by the current acquisition unit is equal to or lower than a fixed value, the main charge unit performs the main charge in the order of batteries having the fewer number of charging and discharging times acquired by the number of charging and discharging times acquisition unit.

(12) A charge control method that includes a current acquisition step of acquiring a charge current value of each battery and a main charge step of performing the main charge for each battery based on the charge current value acquired in the acquiring.

The present disclosure contains subject matter related to that disclosed in Japanese Priority Patent Application JP 2011-245090 filed in the Japan Patent Office on Nov. 9, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A charge control device comprising:
a current acquisition unit that acquires a charge current value of each battery; and
a main charge unit that performs a main charge for each battery based on the charge current value acquired by the current acquisition unit.

2. The charge control device according to claim 1, wherein the main charge unit performs the main charge for each battery in the order of from the highest charge current value.

3. The charge control device according to claim 1, wherein, after a battery selected for the main charge based on a charge current value is fully charged, the main charge unit performs the main charge for a remaining battery based on a charge current value.

4. The charge control device according to claim 1, wherein the current acquisition unit acquires each of the charge current values by performing the test charge for each battery only for a short period of time.

5. The charge control device according to claim 1, being an electronic device using discharged currents from each battery as a power source.

6. The charge control device according to claim 1, wherein the main charge unit switches a battery to be charged when the charge current value of a battery being charged decreases and becomes lower than the current value acquired from a battery not being charged by a fixed value or higher.

7. The charge control device according to claim 1, wherein the main charge unit switches a battery to be charged when the charge current value of a battery being charged decreases, and becomes lower than the current value acquired from a battery not being charged, and then a fixed period of time elapses.

8. The charge control device according to claim 1, further comprising:
a voltage acquisition unit that acquires a voltage value of each battery,
wherein, when the difference between charge current values of each battery acquired by the current acquisition unit is equal to or lower than a fixed value, the main charge unit performs the main charge in the order of batteries having lower voltage values acquired by the voltage acquisition unit.

9. The charge control device according to claim 1 further comprising:
a temperature acquisition unit that acquires the temperature of each battery,
wherein the main charge unit performs the main charge for each battery in the order of from the highest charge current value, excluding a battery of which the temperature acquired by the temperature acquisition unit exceeds a reference value.

10. The charge control device according to claim 1 further comprising:
a full-charge capacity acquisition unit that acquires the full-charge capacity of each battery,
wherein, when the difference between the charge current values of batteries acquired by the current acquisition unit is equal to or lower than a fixed value, the main charge unit performs the main charge in the order of batteries having larger full-charge capacities acquired by the full-charge capacity acquisition unit.

11. The charge control device according to claim 1, further comprising:
a number of charging and discharging times acquisition unit that acquires the number of charging and discharging times of each battery,
wherein, when the difference between the charge current values of batteries acquired by the current acquisition unit is equal to or lower than a fixed value, the main charge unit performs the main charge in the order of batteries having the fewer number of charging and discharging times acquired by the number of charging and discharging times acquisition unit.

12. A charge control method comprising:
acquiring a charge current value of each battery; and
performing a main charge for each battery based on the charge current value acquired in the acquiring.
